(19) United States
(12) Patent Application Publication
(10) Pub. No.: US 2010/0280895 A1
(43) Pub. Date: Nov. 4, 2010

(54) FOOD AND BEVERAGES ORDERING, PREPARATION, MANAGEMENT AND PRICING SYSTEM AND METHOD

(76) Inventor: Sergio Michelangelo Mottola, London (GB)

Correspondence Address: DICKSTEIN SHAPIRO LLP, 1825 EYE STREET NW, Washington, DC, 20006-5403, US

(21) Appl. No.: 12/776,938

(22) Filed: May 10, 2010

Related U.S. Application Data
(63) Continuation-in-part of application No. PCT/IB2009/000045, filed on Jan. 14, 2009.

(51) Int. Cl. G06Q 50/00; G06Q 30/00; G06Q 10/00; G06F 3/048; G06F 17/30; G06K 7/00; G06K 15/02

(52) U.S. Cl. 705/14.24; 705/15; 705/14.1; 715/771; 707/705; 235/380; 358/1.15; 707/E17.044; 707/802; 715/764

(57) ABSTRACT

A computerized food and beverages ordering apparatus implements an ordering service for meeting requirements of purchasers. A database comprises records representative of a plurality of ingredients, and at least two attributes are associated with each ingredient. One of the attributes associated to each ingredient is a nutritional parameter for a specific amount of the ingredient, and another attribute is a personal parameter. The personal parameter can be a parameter capable of describing the suitability of the associated ingredient in respect of a medical condition of a purchaser, or it can be a parameter capable of describing the suitability of the associated ingredient in respect of a taste requirement of a purchaser. A user interface is operated by, or under the instruction of, a purchaser to input an order for a meal. The meal comprises one or more of said plurality of ingredients, and each ingredient has an associated quantity. An order placement processor is connected to the user interface and to the database, and it is configured to output to the user interface at least two output parameters. One of the output parameters is a total nutritional parameter computed from the total quantities of ingredients comprised in the meal. Another output parameter is a personal parameter.

### RELATED APPLICATIONS

This application is a continuation-in-part of PCT patent application number PCT/IB2009/000045 filed on 14 Jan. 2009, the content of which is incorporated in its entirety herein.

### FIELD OF THE INVENTION

The present invention relates to a method and system for ordering, preparing, managing and pricing food and beverages.

### BACKGROUND OF THE INVENTION

On the consumer side of the food retail industry, choice of which products are consumed depends on many factors and circumstances. Often, consumers rely on individual, “subjective” preferences for choosing what they eat or drink. Often, however, the choice depends on “objective” criteria, externally imposed. For example, many people base their everyday choices on specific medical needs, for example that of avoiding dairy products, due to an allergy. Diets, or controlled nutritional regimes, are also very popular among the public. However, conforming nutritional habits to diets or controlled nutritional regimes can be problematic. In other instances, consumers perform their choices on the basis of budgets, allowances or ability of purchase in general.

On the supplier side of the food retail industry, suppliers have tried to facilitate consumer choice, or to influence consumer behaviour, in a number of manners, including by providing nutritional or other type of information regarding their products. For example, supermarkets sell ready-to-eat meals with labels listing their nutritional contents. It is known that ingredients must always be listed on the packaging of industrially produced food and beverage products, according to local legal requirements. Restaurants or fast food outlets have traditionally been less attentive at the problem of supplying food/beverage information to consumers, but they often allow a degree of flexibility to consumers at the moment of choosing a dish or meal unit for consumption (for example many sandwich shops allow the substitution of white bread with granary bread on items included in their menu, or pizza restaurants often allow personalization of pizzas by letting consumers choose their own toppings).

From the above, it is clear that there is a degree of rigidity in the existing ways by which food and beverage products are produced and commercialised, both on the “offer” and on the “demand” sides of the business. Pre-packaged food and beverage products have often been seen as providing a response to the consumers' need for information about the quality and quantity of the products that they consume. However, by definition, pre-packaged foods are not customisable, should they not fulfil a consumer's requirement. On the other side, many fast food outlets or restaurants have often tried to provide a response to the consumer's need for customization. However, it is known that fast food outlets and restaurants fail to provide adequate information about food and beverages selected or chosen by consumers. They also fail to respond quickly and efficiently to consumer customization requests.

There is a need, therefore, to improve both the consumer and the retailer experiences leading to commercial transactions in the food retail industry. There is also a need to offer improved, advanced tools and methods for better matching the “offer” and the “demand” sides of the food retail business.

It is thus an aim of the present invention to provide a system and a method for ordering, preparing, managing and pricing food and beverage products, which solve or at least mitigate the problems found in the art.

### SUMMARY OF THE INVENTION

In an aspect of the present invention, there is provided a computerized method of ordering a meal in combination with calculation and comparison of nutritional values of the meal. The method comprises:
a) providing a database comprising records representative of:
   a plurality of food or beverage items,
   values of at least two nutritional principles associated with each food or beverage item of said plurality of food or beverage items for a reference amount of food or beverage item,
   a plurality of consumable units, wherein at least one food or beverage item can be associated to each consumable unit of said plurality of consumable units;
b) using a user interface to receive a selection of at least one consumable unit from said plurality of consumable units in said database;
c) for each selected consumable unit, using a user interface to receive a user selection of at least one food or beverage item associated with the selected consumable unit, wherein a total of at least two food or beverage items are selected, and wherein each selected food or beverage item has an associated amount;
d) for each selected food or beverage item, using a processor to access said database to acquire at least two values of nutritional principles, the nutritional principles for which values are acquired corresponding to at least two monitor nutritional principles common to all the selected food or beverage items;
e) using the processor to calculate at least two total nutritional values, each total nutritional value being given by a summation of terms, each term corresponding to a selected food or beverage item and each term being calculated by multiplying an acquired value of a nutritional principle by an associated amount of selected food or beverage item;
f) using the user interface to display the total nutritional values; and
g) using the user interface to receive an order for the meal, the meal comprising at least two selected food or beverage items.

According to another aspect of the invention, there is provided a computerized apparatus for ordering a meal and calculating nutritional values of the meal. The apparatus comprises:
a) a database;
b) a processor connected to said database;
c) an input device connected to said processor; and
d) an output device connected to said processor.

The database comprises records representative of:
a plurality of food or beverage items comprised in the meal;
values of at least two nutritional principles associated with each food or beverage item of said plurality of food or beverage items for a reference amount of food or beverage item;
a plurality of consumable units, wherein at least one food or beverage item can be associated to each consumable unit of said plurality of consumable units.

The input device is configured to receive a selection comprising at least one consumable unit comprising at least one food or beverage item of said plurality of food or beverage items, wherein at least two food or beverage items are selected, and is configured to transmit said selection to the processor for processing. The processor is programmed to receive said selection, is programmed to access said database to acquire at least two values of nutritional principles for each food or beverage item comprised in the selection, the nutritional principles for which values are acquired corresponding to monitor nutritional principles common to all the selected food or beverage items, is programmed to calculate at least two total nutritional values, each total nutritional value being given by a summation of terms, each term corresponding to a food or beverage item and each term being given by multiplying an acquired value by a corresponding amount of food or beverage item, and is programmed to output the total nutritional values to the output device. The output device is configured to display the total nutritional values. The input device is operable to receive an order for the meal, the meal comprising at least two selected food or beverage items.

In another aspect of the invention, there is provided a computerized food and beverages ordering apparatus for implementing an ordering service for meeting nutritional requirements of purchasers. The apparatus comprises a database comprising records representative of a plurality of ingredients, wherein at least two attributes are associated with each ingredient, one of the at least two attributes being a nutritional parameter for a specific amount of ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user.

The apparatus also comprises a user interface operable by, or under the instruction of, a purchaser to receive an order for a meal, the meal comprising one or more of said plurality of ingredients, each ordered ingredient having an associated quantity. The apparatus also comprises an order placement engine connected to said user interface and to said database, the order placement engine configured to send to an output user interface at least two output parameters, one of the at least two output parameters being a total nutritional parameter computed from the or a total quantity of respectively the or an ingredient comprised in the meal, and another output parameter of the at least two output parameters being a personal parameter.

According to another aspect of the invention, there is provided a user interface operable by, or under the instruction of, a purchaser to receive an input of an order for a meal. The user interface is for use with:
a) a database comprising records representative of a plurality of ingredients comprising each ingredient comprised in the meal, the meal comprising at least one ingredient, each ingredient having an associated quantity, wherein at least two attributes are associated with each ingredient, one of the at least two attributes being a nutritional parameter for a specific amount of each ingredient, and another of the at least two attributes being a personal parameter, said personal parameter being:
   a parameter capable of describing the suitability of each ingredient associated with a medical condition of a user; or
   a parameter capable of describing the suitability of each ingredient associated with a taste requirement of a user; and
b) an order placement engine connected to the database and configured to retrieve at least one output parameter in response to an order for a meal, each output parameter being a total nutritional parameter calculated from each quantity of ingredient comprised in the meal and respective nutritional parameter for a specific amount of ingredient stored in said database, or a personal parameter. The user interface is configured to transmit the order for the meal to the order placement engine, is configured to receive from the order placement engine at least one output parameter, and is configured to output to the purchaser each output parameter. Further, the user interface is configured to receive a confirmation or modification of the order for the meal in response to the output to the purchaser of each output parameter.

According to a further aspect of the invention, there is provided a computerized method of ordering food and beverages according to personal requirements. The method comprises:
a) providing a database comprising records representative of a plurality of ingredients, wherein at least two attributes are associated with each ingredient, one of the at least two attributes being a nutritional parameter for a specific amount of each corresponding ingredient, and another of the at least two attributes being a personal parameter, said personal parameter being:
   a parameter capable of describing the suitability of each ingredient associated with a medical condition of a user, or
   a parameter capable of describing the suitability of each ingredient associated with a taste requirement of a user;
b) using a user interface to receive a proposed order for a meal, the meal comprising one or more ingredients, each ingredient having an associated quantity;
c) using the user interface to select at least one desired output parameter, the desired output parameter being a total nutritional parameter computed from each quantity of ingredient comprised in the meal and from respective nutritional parameter for a specific amount of ingredient stored in the database, or a personal parameter; and
d) using an ordering processor to retrieve information about the proposed order, said information comprising at least the desired output parameter and to output said information to the user interface.

According to another aspect of the invention, there is provided a computerized food and beverages preparation station for preparing a meal, the meal comprising one or more ingredients, each ingredient having an associated quantity. The station comprises:
a) a meal preparation unit comprising quantities of a plurality of ingredients and equipment required for preparing meals, said quantities comprising each quantity of each ingredient comprised in the meal;
b) database comprising records representative of said quantities of a plurality of ingredients stocked at the meal preparation unit, and records representative of recipes, each recipe comprising a set of instructions for preparing a meal, said recipe records comprising at least one record representative of a recipe for preparing the meal; and
c) a meal preparation engine, the meal preparation engine being connected to the database, and configured to output a recipe for the meal to a staff user interface for an operator of the meal preparation unit.

Each record representative of each quantity of each ingredient comprised in the meal is configured for being updated in the database by the meal preparation engine when the meal is prepared at the meal preparation unit.

According to an aspect of the present invention, there is provided a computerized food and beverages ordering and preparation apparatus for ordering and preparing a meal. The apparatus comprises:
a) a meal preparation unit comprising quantities of a plurality of ingredients and equipment required for preparing meals;
b) a database comprising records representative of said quantities of a plurality of ingredients stocked at the meal preparation unit, and records representative of recipes, each recipe comprising a set of instructions for preparing a meal, said recipe records comprising at least one record representative of a recipe for preparing the meal, wherein at least one attribute is associated with each ingredient of said plurality of ingredients, each attribute being a nutritional parameter for a specific amount of ingredient, or a personal parameter, said personal parameter being:
   a parameter capable of describing the suitability of each ingredient associated with a medical condition of a user, or
   a parameter capable of describing the suitability of each ingredient associated with a taste requirement of a user;
c) a user interface operable by, or under the instruction of, a purchaser to input an order for the meal, the meal comprising one or more stocked ingredients, each ordered ingredient having an associated quantity comprised in the quantities of the plurality of ingredients stocked at the meal preparation station;
d) an order placement engine connected to said user interface for receiving the order for the meal and connected to said database, the order placement engine configured to send to an output user interface at least one output parameter, each output parameter being a total nutritional parameter computed from each total quantity of each stocked ingredient comprised in the meal, or a personal parameter; and
e) a meal preparation engine, the meal preparation engine connected to the database, and configured to send a recipe for the meal to a staff user interface for an operator of the meal preparation unit.

Each record representative of each quantity of each ingredient comprised in the meal is updated in the database by the meal preparation engine when the recipe for the meal is sent to the staff user interface.

In another aspect of the invention, there is provided a user interface operable by, or under the instruction of, an operator of a meal preparation station to process an order for a meal. The user interface is for use with:
a) a database comprising records representative of a plurality of quantities of ingredients stocked at the meal preparation station, said records comprising at least one record representative of one quantity of one ingredient stocked at the meal preparation station and comprised in the ordered meal, the ordered meal comprising at least one ingredient, each ingredient having an associated quantity, and the ordered meal comprising at least one ingredient stocked at the meal preparation station, and records representative of recipes, each recipe comprising a set of instructions for preparing a meal, wherein at least one record of recipe comprises a set of instructions for preparing the ordered meal; and
b) a meal preparation engine connected to the user interface and connected to said database, the meal preparation engine configured for receiving the order for the meal, and configured to retrieve from the database a recipe for the ordered meal and to update in the database each quantity of each stocked ingredient comprised in the meal.

The user interface, in response to a command from the operator to process the order for the meal, is configured to transmit the order for the meal to the meal preparation engine, and is configured to receive, in response thereto, from the meal preparation engine, a recipe for the meal and to display the received recipe to the operator of the meal preparation station. Further, each record representative of a quantity of a stocked ingredient comprised in the meal is updated in the database by the meal preparation engine when the ordered meal is processed.

According to yet another aspect of the invention, there is provided a computerized method of processing an order for a meal. The method comprises:
a) providing a user interface and using the user interface to receive the order for the meal, the meal comprising at least one ingredient, each ingredient having an associated quantity;
b) providing a meal preparation station comprising quantities of a plurality of ingredients and equipment required for preparing meals, said quantities comprising each quantity of each ingredient comprised in the meal;
c) providing a database connected to said user interface comprising records representative of the plurality of quantities of ingredients stocked at the meal preparation station, and records representative of recipes, each recipe comprising a set of instructions for preparing a meal, said recipe records comprising at least one record representative of a recipe for preparing the meal;
d) providing an order fulfilment processor connected to said database and connected to said user interface, the order fulfilment processor configured to receive the order for the meal, configured to retrieve from said database said recipe for the meal, and configured to update in said database each record of each stocked ingredient comprised in the meal;
e) using the user interface to transmit said order for the meal to the order fulfilment processor;
f) using the order fulfilment processor to retrieve said recipe for the meal;
g) using the user interface to visualize said recipe;
h) preparing the meal according to said visualized recipe; and
i) using the order fulfilment processor to update in the database the record or records representative of the quantity or quantities of the stocked ingredient or ingredients comprised in the meal after the order for the meal has been transmitted to the order fulfilment processor.

In another aspect of the invention, there is provided a computerized method of ordering and preparing a meal according to personal requirements. The method comprises:
a) providing an ingredients database comprising records representative of a plurality of ingredients, wherein at least two attributes are associated with each ingredient, one of the at least two attributes being a nutritional parameter for a specific amount of each corresponding ingredient, and another of the at least two attributes being a personal parameter, said personal parameter being:
   a parameter capable of describing the suitability of each ingredient associated with a medical condition of a user; or
   a parameter capable of describing the suitability of each ingredient associated with a taste requirement of a user;
b) providing a user interface and using the user interface to receive an input of a proposed order for a proposed meal, the proposed meal comprising one or more proposed ingredients, each ingredient having an associated proposed quantity;
c) providing an ordering processor connected to said interface and to said ingredients database;
d) transmitting the proposed order for the proposed meal to the ordering processor;
e) using the ordering processor to generate information about the proposed meal, said information comprising at least one output parameter, said output parameter being a total nutritional value computed from at least one quantity of proposed ingredient comprised in the proposed meal and from respective nutritional parameter for a specific amount of ingredient, or a personal parameter;
f) using the ordering processor to transmit said information about the proposed meal to the user interface;
g) using the user interface to visualize said information;
h) providing a meal preparation station comprising quantities of a plurality of ingredients and equipment required for preparing meals, said quantities comprising each quantity of ingredient comprised in the meal, the meal comprising at least one ingredient, each ingredient having an associated quantity;
i) providing a stock database connected to said user interface and comprising records representative of the plurality of quantities of ingredients stocked at the meal preparation station, and records representative of recipes, each recipe comprising a set of instructions for preparing a meal, said recipe records comprising at least one record representative of a recipe for preparing the meal;
j) providing an order fulfilment processor connected to said stock database and connected to said user interface, the order fulfilment processor configured to receive the order for the meal, configured to retrieve from said stock database said recipe for the meal, and configured to update in said database each record of each stocked ingredient comprised in the meal;
k) using the user interface to receive an input to finalize the proposed order for the proposed meal into an order for the meal and transmitting said meal order to the order fulfilment processor;
l) using the order fulfilment processor to retrieve said recipe for the meal;
m) providing a staff user interface and using the staff user interface to visualize said recipe for the meal;
n) preparing the meal according to said visualized recipe; and
o) using the order fulfilment processor to update in the database the record or records representative of the quantity or quantities of the stocked ingredient or ingredients comprised in the meal after the order for the meal has been transmitted to the order fulfilment processor.

According to another aspect of the invention, there is provided a computerized food and beverages label printing apparatus for producing personal labels for a meal. The apparatus comprises a database comprising records representative of a plurality of ingredients, wherein at least one attribute is associated with each ingredient, each attribute being a nutritional parameter for a specific amount of each ingredient or a personal parameter, said personal parameter being:
a parameter capable of describing the suitability of each ingredient associated with a medical condition of a user; or
a parameter capable of describing the suitability of each ingredient associated with a taste requirement of a user.

The apparatus also comprises a user interface operable by, or under the instruction of, a purchaser to receive an order for the meal, the meal comprising one or more ingredients, each ingredient having an associated quantity, and a printing processor connected to said user interface and to said database, the printing processor configured to transmit to a label printer at least one printing parameter. Each printing parameter is a total nutritional parameter computed from at least one quantity of ingredient comprised in the meal and from respective nutritional parameter for a specific amount of ingredient, or a personal parameter. The apparatus also further comprises a label printer connected to said printing engine, the label printer configured to print each output parameter.

In another aspect of the invention, there is provided a method of printing a personalized label for a meal. The method comprises:
a) providing a database comprising records representative of a plurality of ingredients, wherein at least one attribute is associated with each ingredient, each attribute being a nutritional parameter for a specific amount of each ingredient or a personal parameter, said personal parameter being:
   a parameter capable of describing the suitability of each ingredient associated with a medical condition of a user; or
   a parameter capable of describing the suitability of each ingredient associated with a taste requirement of a user,
b) receiving via a user interface an order for the meal, the meal comprising one or more ingredients, each ingredient having an associated quantity;
c) using a printing processor connected to said user interface and to said database to receive the order for the meal and to transmit to a label printer at least one printing parameter, each printing parameter being a total nutritional parameter computed from at least one quantity of an ingredient comprised in the meal and from respective nutritional parameter for a specific amount of ingredient, or a personal parameter;
d) transmitting from the user interface the order for the meal to the printing processor;
e) using the printing processor to generate the at least one printing parameter and to transmit each printing parameter to a label printer; and
f) using the label printer connected to said printing processor to print a personalized label for the meal.

According to a further aspect of the invention, there is provided a computerized apparatus for ordering a meal in combination with performing price and nutritional calculations. The apparatus comprises:
a) a database;
b) a processor connected to said database;
c) an input device connected to said processor; and
d) an output device connected to said processor.

The database comprises records representative of:
a plurality of food or beverage items, comprising each food or beverage item comprised in the meal, the meal comprising at least one consumable unit and each consumable unit comprising at least one food or beverage item, the meal comprising at least two food or beverage items;
values of at least one nutritional principle associated with each food or beverage item of said plurality of food or beverage items for a reference amount of food or beverage item;
values of at least one profit margin and at least one cost parameter associated with each food or beverage item of said plurality of food or beverage items for a reference amount of food or beverage item;
a plurality of consumable units, wherein at least one food or beverage item can be associated to each consumable unit of said plurality of consumable units.

The input device is configured to receive an input comprising each consumable unit and each food or beverage item comprised in the meal, and is configured to select at least one monitor nutritional principle, and is also configured to transmit said input to the processor for processing. The processor is programmed to receive said input, is programmed to access said database to acquire a nutritional value for each selected monitor nutritional principle for each food or beverage item comprised in the meal, is programmed to access said database to acquire values of a profit margin and a cost parameter for each food or beverage item comprised in the meal, is programmed to calculate a total nutritional value for each selected monitor nutritional principle, each total nutritional value being given by a summation of terms, each term corresponding to a food or beverage item and each term being given by multiplying an acquired nutritional value by a corresponding amount of food or beverage item, is programmed to calculate a total price of the meal given by a summation of terms, each term corresponding to a food or beverage item and each term being given by multiplying a difference between an acquired value of a profit margin and a cost parameter by a corresponding amount of food or beverage item, and is programmed to output each total nutritional value and the total price of the meal to the output device. The output device is configured to display each total nutritional value and the total price of the meal, and is also operable to place an order for the meal.

According to another aspect of the invention, there is provided a computerized method of ordering a meal in connection with price and nutritional calculations. The method comprises:
a) providing a database comprising records representative of:
   a plurality of food or beverage items,
   values of at least two nutritional principles associated with each food or beverage item of said plurality of food or beverage items for a reference amount of food or beverage item,
   values of at least one profit margin and at least one cost parameter associated with each food or beverage item of said plurality of food or beverage items for a reference amount of food or beverage item;
   a plurality of consumable units, wherein at least one food or beverage item can be associated to each consumable unit of said plurality of consumable units,
b) providing a user interface connected to said database and using the user interface to receive a selection of at least one consumable unit from said plurality of consumable units;
c) for each selected consumable unit, using the user interface to receive a selection of at least one food or beverage item associated with the selected consumable unit, wherein a total of at least two food or beverage items are selected, and wherein each selected food or beverage item has an associated quantity;
d) using the user interface to receive a selection of at least one monitor nutritional principle;
e) providing at least one processor, each processor connected to said interface and to said database;
f) for each selected food or beverage item, using a processor to access said database and to acquire a value of a nutritional principle for a reference amount of food or beverage item for each selected monitor nutritional principle;
g) for each selected food or beverage item, using a processor to access said database to acquire values of a profit margin and a cost parameter for a reference amount of food or beverage item;
h) using a processor to calculate a total nutritional value for each selected monitor nutritional principle, each total nutritional value being given by a summation of terms, each term corresponding to a selected food or beverage item and each term being calculated by multiplying an acquired nutritional principle for a reference amount of food or beverage item by a corresponding amount of selected food or beverage item;
i) using a processor to calculate a total price of the selected food or beverage items given by a summation of terms, each term corresponding to a selected food or beverage item and each term being given by multiplying a difference of acquired values of a profit margin and a cost parameter by a corresponding amount of food or beverage item,
j) using the user interface to display each total nutritional value and the total price of the selected food or beverage items; and
k) using the user interface to receive an order for the meal, the meal comprising at least one selected consumable unit and each consumable unit comprising at least one selected food or beverage item, the meal comprising at least two selected food or beverage items.

According to another aspect of the invention, there is provided a computerized apparatus for discounting a price of a meal, the apparatus comprising:
a) a database;
b) a processor connected to said database; and
c) an input device connected to said processor.

The database comprises records representative of a plurality of food or beverage items, said records comprising at least one record of food or beverage item comprised in the meal having an associated discount parameter. The input device is configured to receive an input comprising each consumable unit and each food or beverage item comprised in the meal, the meal comprising at least one consumable unit and each consumable unit comprising at least one food or beverage item, and the input device is also configured to transmit said input to the processor for processing. The processor is programmed to receive said input, is programmed to access said database to acquire at least one discount parameter associated with a food or beverage item comprised in the meal, and is programmed to calculate a total discount applicable to the meal.

According to a further aspect of the invention, there is provided a method of discounting a price of a meal, the method comprising:
a) providing a database comprising records representative of a plurality of food or beverage items, said records comprising at least one record of food or beverage item comprised in the meal having an associated discount parameter;
b) providing a processor connected to said database; and
c) providing an input device connected to said processor;
d) using the input device to receive an order for each consumable unit and each food or beverage item comprised in the meal, the meal comprising at least one consumable unit and each consumable unit comprising at least one food or beverage item,
e) transmitting said input to the processor for processing;
f) using the processor to receive said input, to access said database to acquire at least one discount parameter associated with a food or beverage item comprised in the meal, and to calculate a total discount applicable to the meal.

According to another aspect of the invention, there is provided a computerized method of ordering a meal in a food and beverages retail outlet according to nutritional information about the meal provided to a user of the outlet. The method comprises:
a) providing a database comprising records representative of:
   a plurality of food or beverage items available at the retail outlet,
   values of at least two nutritional principles associated with each food or beverage item of said plurality of food or beverage items for a reference amount of food or beverage item,
   a plurality of consumable units, wherein at least one food or beverage item can be associated to each consumable unit of said plurality of consumable units;
b) using a user interface at the retail outlet to receive a selection of at least one consumable unit from said plurality of consumable units in said database;
c) for each selected consumable unit, using the user interface at the retail outlet to receive a user selection of at least one food or beverage item associated with the selected consumable unit, wherein a total of at least two food or beverage items are selected and wherein each selected food or beverage item has an associated amount;
d) for each selected food or beverage item, using a processor to access said database to acquire at least two values of nutritional principles, the nutritional principles for which values are acquired corresponding to at least two monitor nutritional principles common to all the selected food or beverage items;
e) using the processor to calculate at least two total nutritional values, each total nutritional value being given by a summation of terms, each term corresponding to a selected food or beverage item and each term being calculated by multiplying an acquired value of a nutritional principle by an associated amount of selected food or beverage item;
f) using the user interface to display the total nutritional values to the user at the retail outlet; and
g) ordering the meal at the food and beverages retail outlet, the meal comprising the at least two selected food or beverage items.

The present invention can be implemented using dedicated digital equipment and/or programmable processing equipment such as suitably programmed general purpose computers. Further, the present invention can be implemented by a single processing apparatus or a number of processing apparatuses in network configuration. The present invention can thus be implemented by suitably programming one or more computers. Therefore, the present invention encompasses computer program code for controlling a digital storage device or devices and processing apparatus or apparatuses which implement the system and method of the present invention. The computer program can be embodied on any suitable storage medium i.e. a storage medium such as a floppy disk, hard disk, tape device, CD-ROM, DVD or solid state memory device.

### BRIEF DESCRIPTION OF THE DRAWINGS

Further features and advantages of the present invention will be apparent from the following description of embodiments thereof, which is given by way of illustration and without limitation with reference to the accompanying figures in which:

FIG. 1 is a schematic representation of a system in accordance with an embodiment of the present invention;

FIG. 2 is a flow chart of a method for selecting a dish and displaying a graphical element according to an embodiment of the present invention;

FIG. 3 shows a possible embodiment of a graphical element representative of the aggregate nutritional value of a dish according to an embodiment of the present invention;

FIG. 4A is a schematic representation of a food and beverages ordering, preparation, management and pricing system according to an embodiment of the present invention;

FIG. 4B is a schematic representation of a food and beverages ordering, preparation, management and pricing system according to an embodiment of the present invention;

FIG. 5A shows a schematic representation of the data structure of the ingredients database of FIG. 4B;

FIG. 5B shows a tree representation of the composition and total parameters of a meal according to the ingredients database of FIG. 5A;

FIG. 6A shows a schematic representation of the data structure of the stock database of FIG. 4B;

FIG. 6B shows examples of records stored in the stock database of FIG. 6A;

FIG. 7 is a flow diagram representing a method of ordering a dish using the system of FIG. 4B;

FIG. 8 is a flow diagram of a method of preparing a meal, a dish, or a compound ingredient using the system of FIG. 4B;

FIG. 9 is a schematic representation of a system with multiple food and beverages preparation stations depending on a central food and beverages ordering station according to an embodiment of the present invention;

FIG. 10 is an example of a screen displayed on an in-store user terminal of the system of FIG. 4A, with one output parameter outside a limit;

FIG. 11 is an example of a screen displayed on an in-store staff terminal of the system of FIG. 4B.

### DETAILED DESCRIPTION OF EMBODIMENTS

The nutritional principle values for a predetermined amount of each food item are assumed herein to be known to those skilled in the art, and will not be indicated herein.

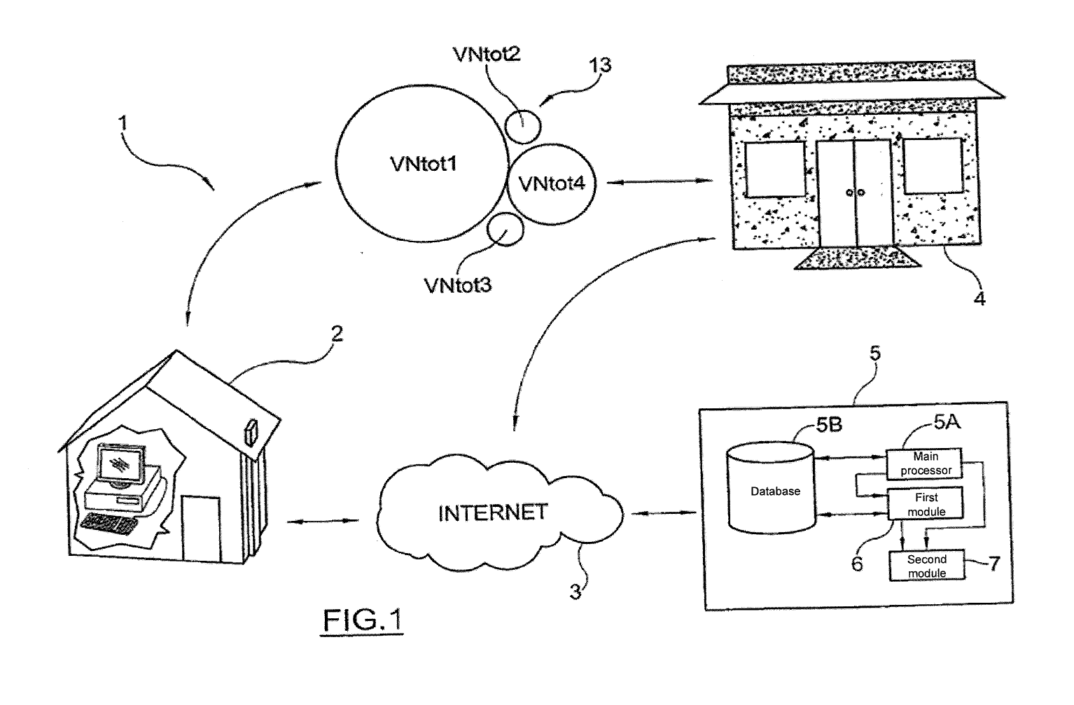

The above being assumed and referring to FIG. 1, numeral 1 generally designates a system for calculating the nutritional value of at least one dish.

The system 1 comprises an Internet station 2 of a user/consumer, a network connection 3, a point of sale 4, a server 5 in which a main processor 5A and a database of nutritional principles 5B are configured. It shall be noted that while the Internet station 2 may be the home or office of the user/consumer, such Internet station 2 may also be located at or near the point of sale 4. Particularly, the Internet station 3 comprises all hardware and software elements required for displaying the data transmitted through the network connection 3 on a graphical interface. The network connection 3 is a TCP/IP based Internet connection.

Preferably, the server 5 of the system 1 also incorporates:
a first module 6 designed to store a plurality of records into the database 5B and retrieving such records in response to user/consumer requests transmitted through the Internet station 2;
a second module 7 associated with the first module 6 and the main processor 5A, such second module 7 being designed to transmit a graphical element 13 to the Internet station 2.

The first module 6 and the output module 7 can be implemented by a Web-based technology, such as Java, Flash languages and the like.

Particularly, the first module 6 is designed to store a plurality of records into the database 5B and retrieving them in response to user/consumer requests transmitted through the Internet station 2.

The second module 7 is designed to transmit the graphical element 13 through the network connection 3 to the Internet station, for it to be displayed on the graphical interface of such Internet station. The graphical element 13 is processed by the processor 5A in response to user/consumer requests.

In this embodiment, the records stored in the database 5B comprise:
a plurality of food items A1, . . . , An,
the value of at least one nutritional principle associated with each food item of said plurality of food items A1, . . . , An for a predetermined amount “q” of the food item,
a plurality of dishes P1, Pn and at least one food item A1, . . . , An that can be associated with each dish of said plurality of dishes P1, Pn.

Therefore, the records in the database 5B include the value of at least one nutritional principle associated with each food item of the plurality of food items A1, . . . , An for a predetermined amount “q” of the food item.

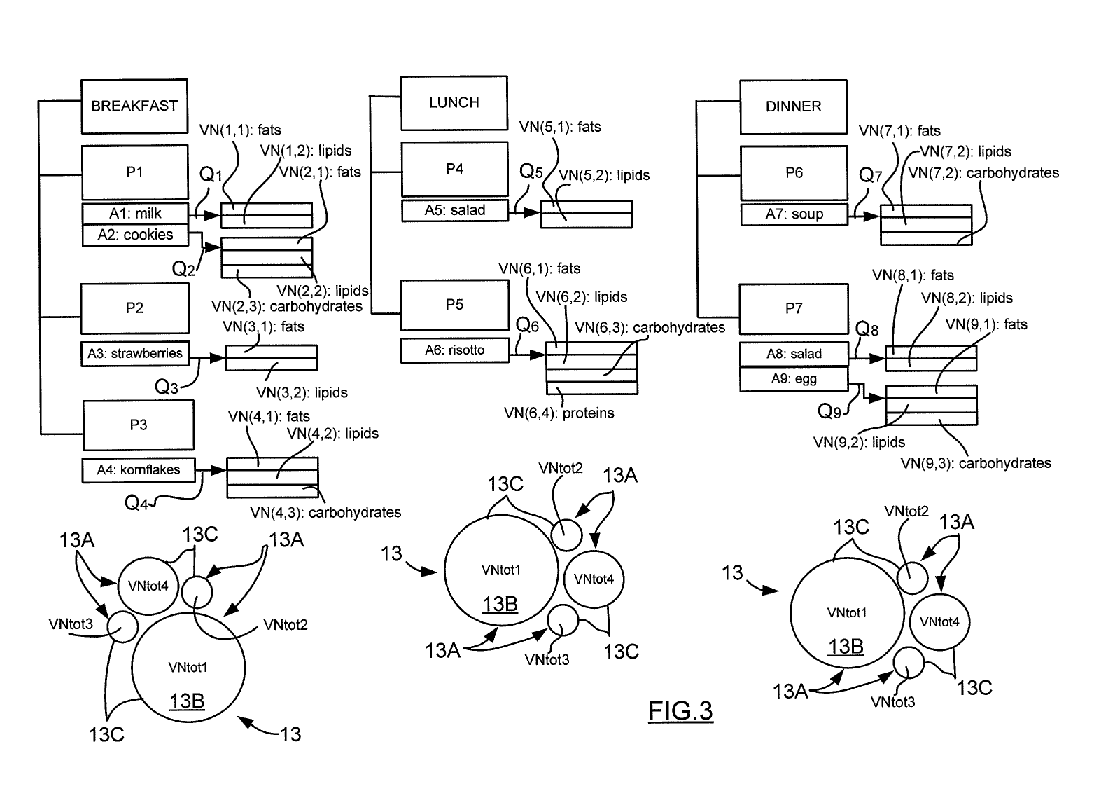

For instance, also referring to FIG. 3, the records in the database 5B may include:
food item A1=milk, that can be associated with the dish P1, the values of nutritional principles VN (1, 1)=fats and VN (1, 2)=lipids calculated for the predetermined amount “q”, i.e. 1 g of milk;
food item A2=cookies, that can be associated with the dish P1, the values of nutritional principles VN (2, 1)=fats and VN (2, 3)=carbohydrates calculated for the predetermined amount q, i.e. 1 g of cookies;
food item A3=strawberries, that can be associated with the dish P2, the values of nutritional principles VN (3, 1)=fats and VN (3, 2)=lipids calculated for the predetermined amount “q”, i.e. 1 g of strawberries, etc.

In other words, the records include both the dishes P1, Pn, with which the various food items A1, . . . , An are associated, and the values of the nutritional principles that form each food item A1, . . . , An, such values of the nutritional principles being calculated for the amount “q” of one gram of the respective food item A1, . . . , An.

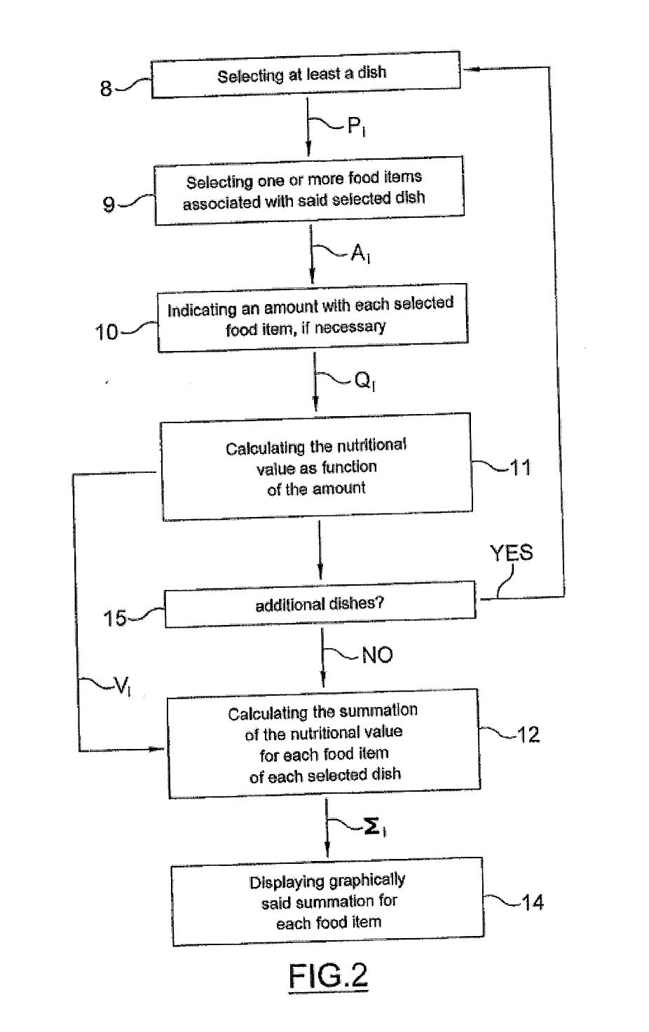

In one embodiment, the graphical element 13 is representative of the summation of the nutritional value calculated for each food item A1, . . . , An of each selected dish P1, . . . , Pn as a function of the amount Qi selected by the user/consumer, to obtain in real time the summation of the nutritional value of the selected dish or dishes, as explained in greater detail with reference to FIGS. 2 and 3.

It shall be further noted that, once the user/consumer has selected the dish or dishes, the first module 6 and the second module 7 are operably designed to accept electronic payments and allow the dish or dishes to be collected at the point of sale 4.

For this purpose, the point of sale 4 comprises an Internet station, which is designed to receive the data processed through the server 5.

In this embodiment, the Internet station of the point of sale 4 is designed to both receive the selected dishes and check the payment status and manage the time of collection of these dishes by the user/consumer.

Referring now to FIG. 2, there is shown the flow chart of the method for calculating the nutritional value of at least one dish P1, . . . Pn.

This method includes the steps of:
selecting 8 at least one dish Pi from said plurality of dishes P1, . . . Pn,
selecting 9 one or more food items Ai that can be associated with said at least one selected dish Pi,
associating 10 an amount Qi with each selected food item Ai, if necessary
accessing said database 5B to acquire the value of at least one nutritional principle associated with each selected food item Ai.

This method comprises the additional steps of:
calculating 11 the nutritional value “VNtoti” as a function of the amount Qi of each food item Ai of each selected dish Pi, and
displaying 14, for each nutritional principle, the graphical element 13 representative of the summation Σi of the nutritional value calculated for each food item Ai of each selected dish Pi, step 12.

Therefore, with this method the graphical element 13 may be used to display on the graphical interface, in real time, i.e. upon selection of the dishes, the food items and relevant amounts, the summation of the nutritional value calculated for each food item A1, . . . , An of each selected dish P1, . . . , Pn as a function of the amount Qi selected by the user/consumer.

The method further includes the step of having the option of selecting additional dishes 15 and, in the affirmative case (YES branch), the steps 8 to 11 as described above are designed to be repeated. If the user/consumer does not want to add any additional dish (NO branch), the method proceeds to steps 12 and 14.

Advantageously, also referring to FIG. 3, the graphical element 13 comprises a plurality of sectors, each 13A of which defines an area 13B delimited by a perimeter 13C.

In this embodiment, the area 13B of each sector 13A is associated with the value VNtoti of each nutritional principle calculated for each food item Ai of said at least one selected dish Pi. In other words, the area 13B of each sector 13A represents the sum of the total energy value VNtoti of one of the nutritional principles in the selected food item Ai of one or more of the selected dishes Pi. In one embodiment, the area 13B of each sector 13A may change according to the value of this sum, which means, for instance, that the higher the value of the calculated sum the greater the area 13B covered by the respective sector.

Such change allows the user/consumer to assess at a glance the amount of nutritional principle for the selected amount Qi of the selected food item Ai.

In one embodiment, the area 13B of each sector 13A of the graphical element 13 changes according to a linear function with the value of said sum. Otherwise, one sector of the plurality of sectors 13A of the graphical element may be arranged to change, whereas the other areas 13B of the remaining sectors have a fixed, constant and predetermined value.

By this arrangement, the total content of certain nutritional principles in the selected dish Pi may be advantageously highlighted, to monitor those that are deemed to be more important for the diet of the user/consumer.

Furthermore, the sectors 13A of the graphical element 13 are grouped close to each other so that a gap is provided between each pair of perimeters 13C. Such gap between the perimeters 13C is preferably less than one fifth of the value of the perimeter 13V of the sector 13A with the smallest area 13B. In other words, the spacing between the sectors 13A that compose the graphical element 13 is less than ⅕ of the value of the perimeter of the sector with the smallest area, i.e. the sector 13A that represents the minimum nutritional value, according to the selected amount Qi.

In order to assist the user/consumer in determining the overall nutritional value VNtoti of each food item Ai of the selected dish Pi, an acronym representative of the nutritional principle (not shown) is displayed inside said perimeter 13C, i.e. within the area 13B of each sector of the plurality of sectors 13A.

Furthermore, in a further step of the present method, for each nutritional principle, the nutritional value VNtoti of each food item Ai of each selected dish Pi is compared with a predetermined nutritional value of the same food item. If the nutritional value VNtoti is higher than the predetermined nutritional value, then the sector 13A of the graphical element 13 for such nutritional principle will be changed.

For example, if the nutritional value VNtoti of the selected dish Pi is higher than the indicated Recommended Daily Allowance (RDA), then the user/consumer will be promptly informed by an aesthetic characterization of the sector 13A associated with that nutritional principle which has, for instance, exceeded the suggested limits of the Recommended Daily Allowance.

Such aesthetic characterization preferably consists in causing that sector to flash with a predetermined frequency to create a blinking effect.

It shall be noted that while the plurality of sectors 13A of the graphical element 13 are embodied as circumferences, they might also be formed with other similar shapes.

Still referring to FIG. 3, which shows a possible embodiment of the graphical element 13, the user/consumer is also allowed to choose from a plurality of dishes P1, . . . , P7, e.g. being part of breakfast, lunch and/or dinner. FIG. 3 shows that each dish P1, . . . , P7 is composed of one or more food items A1, . . . A9 which in turn contain at least one nutritional principle v1,1, . . . , v9,3.

For instance, if for breakfast the user/consumer wishes to select:
the dish P1, with which the food items A1, milk and A2, cookies, are associated,
the dish P2, with which the food item A3, strawberries, is associated, and
the dish P3, with which the food item A4, cornflakes, is associated, and wishes to set, for each food item A1, . . . A4, a given amount, Q1, . . . Q4 respectively, then the system will display the graphical element 13 through the output module 7.

Each sector 13A of the graphical element 13 relates to the sum of the nutritional values

VNtot calculated for each food item A1, A4 of the selected dishes P1, P2 and P3, as a function of the selected amount Q1, Q2, Q3 and Q4.

Then, the system may calculate the nutritional value VNtot, considering that the storage module 6 has been used to save the values of the nutritional principles associated with each food item A1, . . . A4 for a predetermined amount of the food item, in the records of the database 5B.

For example, the overall value VNTOT1 of the nutritional principle VN1, such as fats, as exemplified in FIG. 3, for the selected dishes P1, P2 and P3 and as a function of the indicated amounts Q1, Q2, Q3 and Q4, can be calculated using the following formula:

$$VNTOT 1 = {\sum }_{i} Qi * VN ( i , 1 )$$

which means:

VNTOT2=Q1*VN(1,1)+Q2*VN(2,1)+Q3*VN(3,1)+Q4*VN(4,1)

This also applies to the overall value of the other nutritional principles VN2, lipids, or VN3, carbohydrates, or VN4, proteins, etc.

It should be noted that the calculation of the value VNTOTi of a general nutritional principle VNi may be also expressed for dishes Pi belonging to breakfast, lunch and/or dinner.

In the remainder of this section, we will generally refer to “Meals” to indicate a set of dishes or food or beverage items or products that a user or purchaser wishes to order for consumption. “Breakfast”, “Lunch” and “Dinner”, as used in FIG. 3, are examples of “Meals”. We will also generally refer to “Recipes” to identify a single food or beverage unit or product or item that may be consumed alone or in conjunction with other units or items to form a “Meal”. Therefore, according to this definition of “Recipes”, the dishes P1, . . . Pn described above are examples of “Recipes”. Each “Recipe” is generally associated to a set of instructions for the preparation thereof, either by cooking or by assemblage (this latter term referring to mixing, stirring, coupling or any other operation not involving the use of heat). We will also generally refer to “Ingredients” to identify the individual components of each “Recipe”. Thus, according to this definition of “Ingredients”, the food items A1, . . . , An described above can be taken as examples of “Ingredients”. Further, the “Ingredients” category will be divided into “Single Ingredients” and “Compound Ingredients”, the former referring to unprocessed materials, for example as received by a supplier, for example row leaves of baby spinach, and the latter referring to materials that have been processed (in any of the ways detailed above) in a store, outlet or restaurant. Each “Recipe” can comprise one or more “Ingredients”. If more “Ingredients” are present in one “Recipe”, they will be assembled, cooked or prepared into the “Recipe” according to an associated set of instructions.

In the following section the total quantities of “Ingredients” Qi, as described above are referred to. The nutritional values for a given quantity (for example 1 gram) of “Ingredient” VN(i, k) will also be referred to, as defined above, where the index “i” refers to the “Ingredients” and the index “k” refers to the nutritional principles (e.g. k=2 for lipids, k=3 for carbohydrates, etc . . . ), as illustrated in FIG. 3.

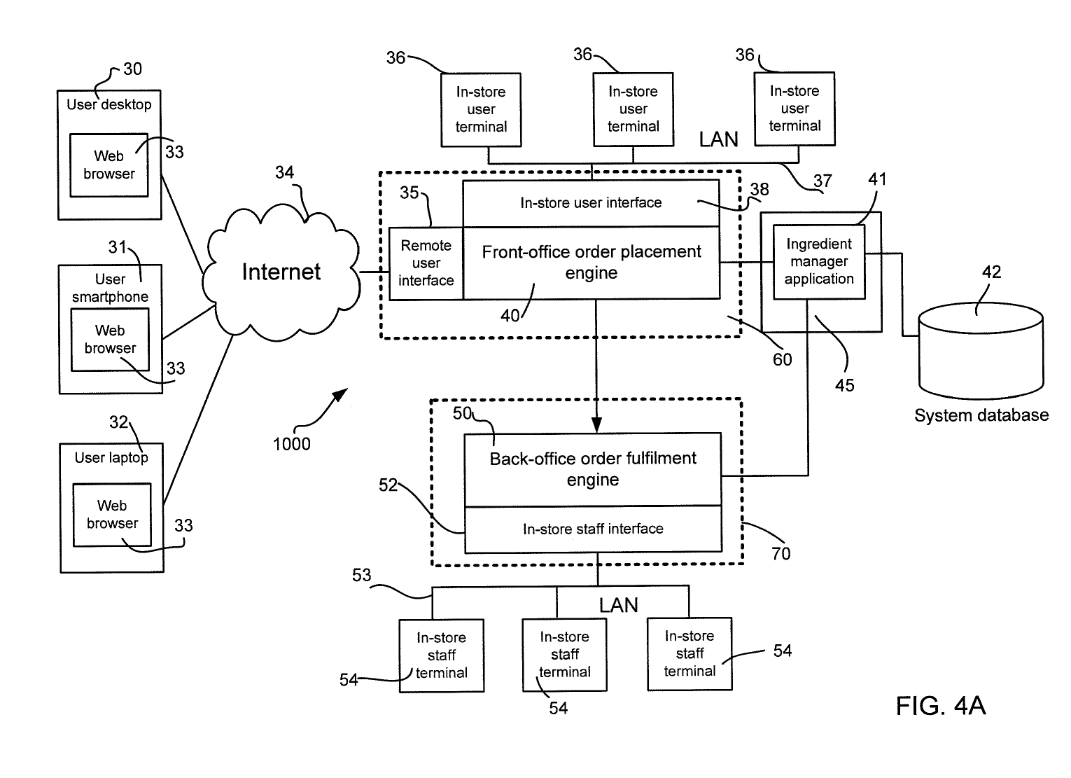

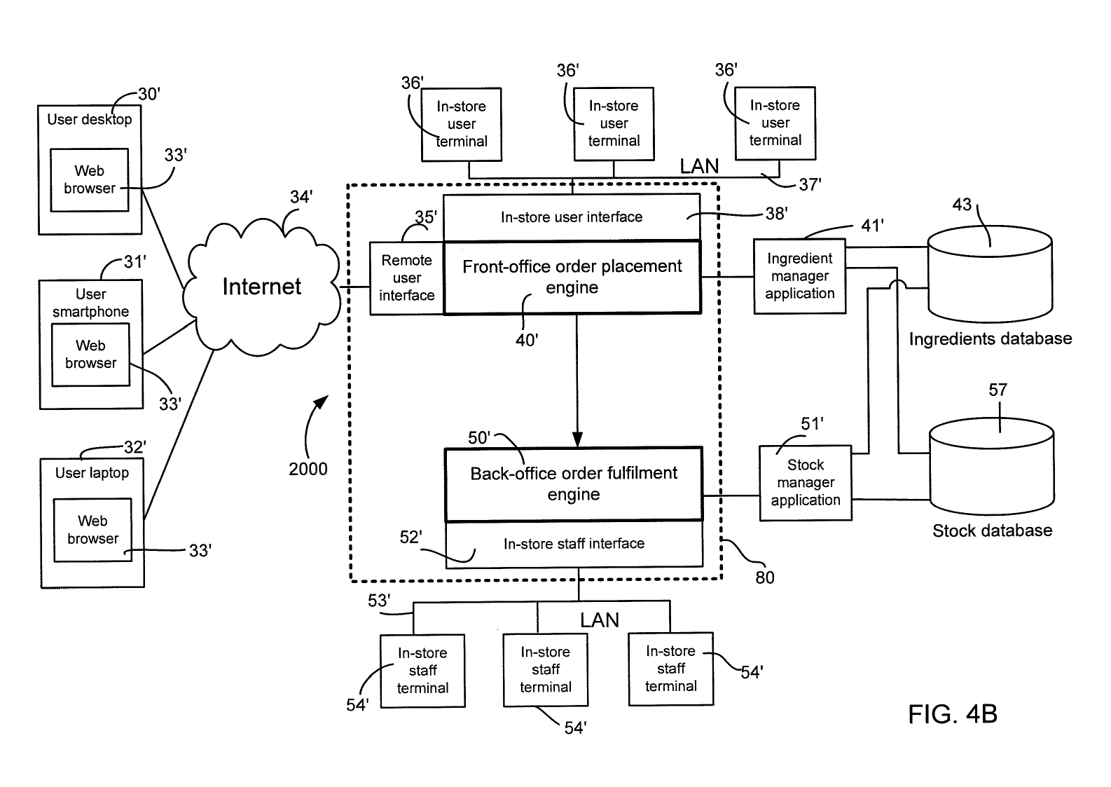

FIG. 4A represents an embodiment of a system 1000 configured in accordance with the present invention. We will now describe in detail the system 1000, which in this instance is used to run, manage and operate a fast food retail outlet. It will be recognized, however, that the system 1000 can be used in any kind of restaurant or food and beverages outlet, or other retail unit.

The system 1000 involves the use of remote ordering devices as well as in-store ordering devices. To order a meal remotely, a user (or purchaser) has access to a user desktop 30, a user smart-phone 31 or a user laptop 32. The user desktop 30, smart-phone 31 and laptop 32 are all equipped with a web browser 33. The web browser 33 is capable of accessing Internet 34 content, as known by the public. The content accessed by remote users of the system 1000 is made available by a remote user interface 35, which interacts with a “Front-Office Order Placement Engine” (FOOPE) 40, which is the kernel of the system 1000, as it will be described later. The remote user interface 35 allows a customer to input an order remotely. To order a meal in-store, a user (or purchaser) has access to in-store user terminals 36, each comprising input and output devices which could be of any type known in the art. In this embodiment, the terminals 36 are equipped with touch-screens, which are particularly convenient for this purpose (the touch-screens are not shown in FIG. 4A). Alternatives to touch-screens are however possible, for example the input operations can be performed via ordinary mice or keypads, and the output operations can be performed via ordinary monitors or printers. The in-store terminals 36 are used to output content made available to them by an in-store user interface 38, which also interacts with the FOOPE 40, as shown in FIG. 4A. In this embodiment, the in-store user terminals 36 display the content of the in-store user interface and are connected to the FOOPE by a Local Area Network (LAN) connection 37, but it is evident that other methods of connection could be used, for example via a Wireless LAN, as it is known in the art.

The FOOPE 40 of the system 1000 shown in FIG. 4A is provided on a server programmed to execute a series of operations, as it will be described below. One or more programming languages are used for programming the operations performed by the FOOPE 40, for example “C”, “C++” or “Visual Basic”, as it is common in the art. Other object-oriented programming languages are also possible, especially because of their convenient handling of data by virtue of programming features like encapsulation and inheritance. Further, the FOOPE 40 operates in connection with an ingredient manager application 41, which can reside in the same server of the FOOPE 40, or can reside in a different computer. In this embodiment, the ingredient manager application is installed in a secondary computer 45. The ingredient manager application 41 is effectively an interface between the FOOPE 40 and a system database 42. The system database 42 is the repository of all the information that is necessary for the FOOPE 40 to perform its operations, as it will be described in detail later. The system database 42 can fulfill any information request generated by the FOOPE 40. A request for information generated by the FOOPE 40 is transmitted to the ingredient manager application 41, which interrogates the system database 42. The ingredient manager application can also be accessed directly, i.e. independently of the FOOPE 40, for example by an administrator of the system 1000 if he needs to input records into the system database 42. The information stored in the system database is capable of fulfilling any information request elaborated by the FOOPE 40. Nutritional information ingredient by ingredient, as described hereinbefore, is one particulat type of information that can be stored in the system database 42. However, the system database can store other information as long as the information generally relates to attributes or properties of the products or ingredients produced and or sold in the restaurant.

The FOOPE 40 is programmed to process an initial proposed order instruction, which is input by the user via the remote 35 or in-store 38 user interfaces. The order is generally for a meal or for a single dish or drink. The instruction for a proposed order can be accompanied by an instruction that the order should not be processed by the FOOPE 40, in which case the proposed order is simply passed to the “Back-Office Order Fulfillment Engine 50” (BOOFE) for implementation. Like the FOOPE 40, the BOOFE 50 is also provided on a suitably programmed server. A single server machine can be shared between the FOOPE 40 and the BOOFE 50. However, in FIG. 4A, the FOOPE 40 and BOOFE 50 are implemented on two different servers, respectively the FOOPE server 60 and the BOOFE server 70.

The FOOPE 40 is generally used to process the proposed order instruction and to provide a proposed order output to the user in response to an order being instructed or placed. The FOOPE 40 requests the ingredients manager application 41 to locate records of food or beverage meals, recipes or ingredients constituting or comprised in the order, in the system database 42. The FOOPE 40 then calculates one or more output parameters to be returned to the user via for example one of the in-store terminals 36 or the remote connection devices 31, 32, 33, as the case may be. One or more of the parameters computed by the FOOPE 40 can be dependent on the quantities of the meals, recipes or ingredients specified by the user in his order (for example a nutritional parameter expressing the total grams of proteins included the order or in part of the order, for example a single dish or drink or even a single ingredient). Other parameters can, however, be independent from such quantities (for example a nutritional parameter expressing whether the order is suitable for vegetarians—this will just depend on whether any meat is present in the order). The FOOPE 40 is therefore responsible for generating an output comprising one, two or multiple parameters associated with the order. As we have already seen, such output will contain qualitative and quantitative attributes or characteristics or other general properties of the food and beverage items or meals, recipes and ingredients comprised in, or constituting, the order. We will describe later in more detail examples of calculations and operations performed by the FOOPE 40. It is however pointed out at this stage that these calculations can be basic (for example comprising sums and multiplications, e.g. for calculating the total proteins of a meal, as described hereinbefore) or could encompass more sophisticated calculation algorithms. The degree of complexity of the FOOPE 40 calculations is not part of the present invention, which instead is defined by how the FOOPE 40 interacts with the other elements of the system 1000 and by how the system 1000 interacts with the end user. The output parameter or parameters generated by the FOOPE 40 can be default parameters of general interest (for example “vitamins” and “fats”), or they could be chosen by the user for example from a list provided to the user on the in-store user interface 38. In this way, the system engages even more with the user by allowing him to monitor his selection of parametes. For example, a certain user may be interested in finding out how many calories there are in a proposed meal, but also he would like to know whether any onions are present in the proposed meal, because he would like to avoid them. Another user may need to monitor the total intake of iron connected with the proposed order, because of a medical condition.

As it has been described in detail at the beginning of this section, the output generated by the FOOPE 40 can be conveniently represented by a graphical element 13.

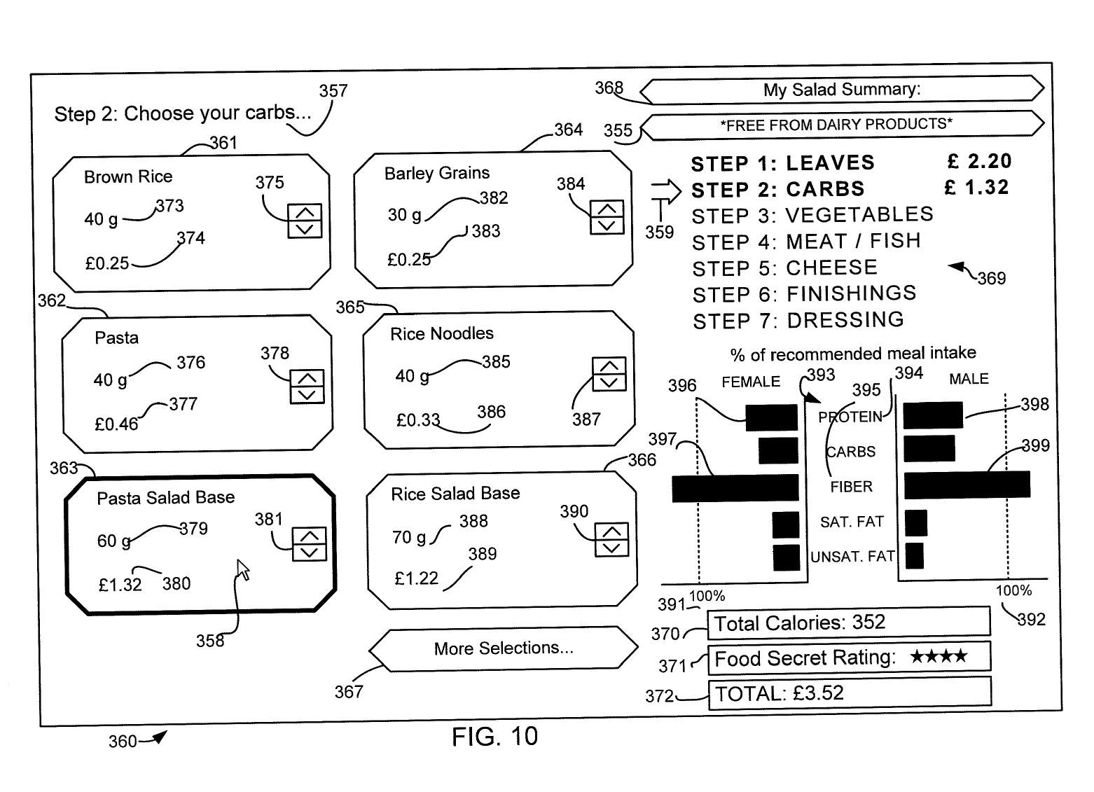

The information generated by the FOOPE 40 is visualized to the in-store user at one of the in-store terminals 36, or to a remote user via the Internet 34. FIG. 10 shows an example of a screen display as seen by an in-store user at one of the terminals 36 in response to a proposed order for a meal.

The feedback and information received about the order allows the user to decide whether to maintain the proposed order or whether to change it. If the proposed order is changed, a new output is or may be calculated by the FOOPE 40, and then displayed. The decision can be facilitated by a number of decision instruments that can appear in the screen display, as shown in FIG. 10, where a bar-chart is used for comparing the quantity of proteins provided by the order with a recommended daily allowance (RDA). The comparison is drawn on the basis of percentage RDA.

When an order is finalized by the user by sending a corresponding instruction to the FOOPE 40 via the user interface, the FOOPE 40 transmits the finalized order to the BOOFE 50. The BOOFE 50, in turn, makes the finalized order available to the staff of the fast food outlet through the in-store staff terminals 54. The content of the screens displayed at the in-store staff terminals (which, like the user terminals, are integrated input/output devices, in this case touch-screens) is provided by an in-store staff interface application 52, which runs in the BOOFE 50 server and which interacts with the BOOFE 50. It will also be noted that the BOOFE server 70 is connected to the system database 42 via the ingredients manager application secondary computer 45. This connection allows information from the system database 42 to be used by the BOOFE when necessary. The in-store staff interface 52 is active on the staff terminals 54 by means of a LAN 53 which connects the back-office server 70 with the terminals 54. A characteristic of the BOOFE 50 is that it comprises a prioritization algorithm, which is designed to guide the store staff in determining which order—if many have been passed to the BOOFE 50 by the FOOPE 40—should be fulfilled first. Based on the orders loaded in the BOOFE 50, and on the fulfillment priority established by the priority algorithm, member of staff will select the next order to be fulfilled or prepared, and thereafter will prepare or cook food and beverage items according to the order and deliver them to the user or purchaser. The delivery can be in-store or remote delivery can be arranged in the usual ways.

A customer of the fast food outlet running the system 1000 experiences the “front office” part of the system, which allows the customer to retrieve at “till” level information about proposed orders via one of the user terminals 36, and to make a decision on what to consume based on that information. A member of staff of the fast food outlet experiences the “back office” part of the system, which allows the staff member to fulfill orders on the basis of information that can be retrieved form the system database 42, like recipes for the order. The staff member, if authorized, can also access the ingredient manager application to update any records or to create new records or attributes for the ingredients, meals or individual dishes. In an embodiment, the system database comprises records of the quantities of ingredients stored in the fast food restaurant and these records are automatically updated in the database 42 when an order is fulfilled; when an ingredient becomes unavailable, the user interface will not allow the user to select the unavailable ingredient. When the ingredient is re-stocked, the staff member or an administrator will reset the corresponding record in the system database 42 to the quantity re-stocked.

FIG. 4B shows a variant of the system represented in FIG. 4A. In this alternative embodiment 2000, the system database 42 is replaced by two separate databases: the ingredients database 43 and the stock database 57.

In order to describe the operations of the FOOPE 40 and the BOOFE 50 of this system 2000, it will be necessary to first describe the basic characteristics of the ingredients database 43 and of the stock database 57.

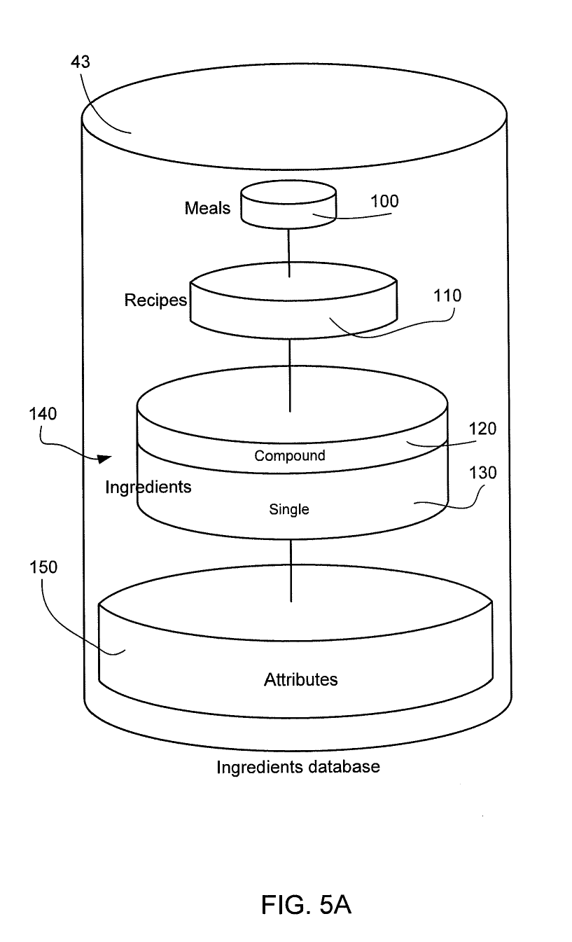

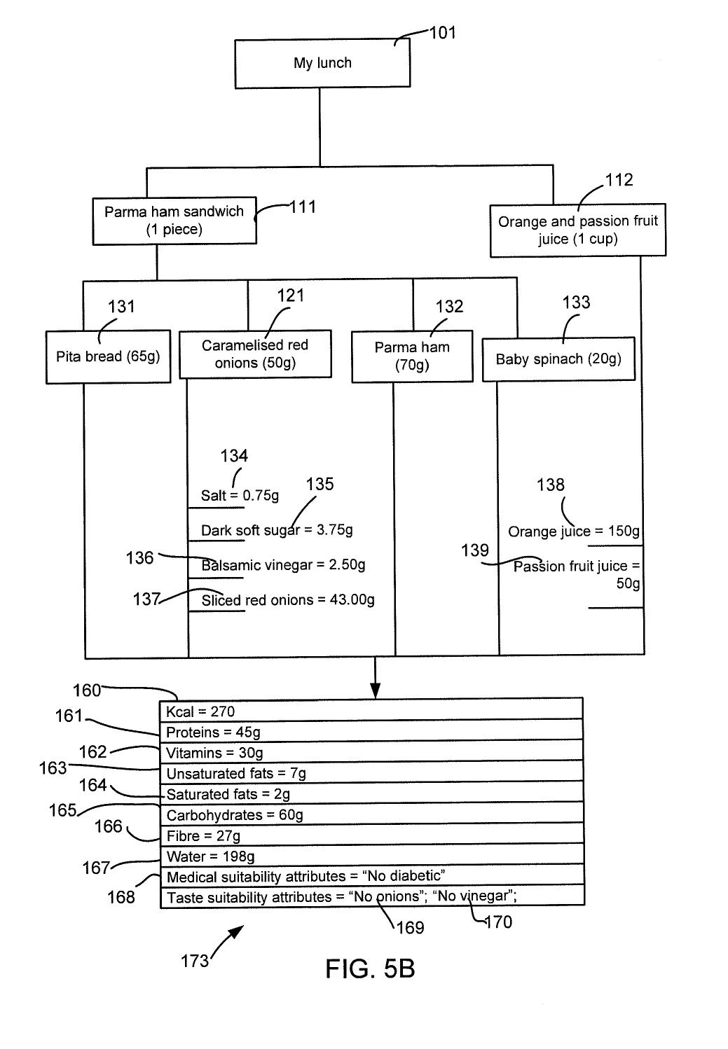

The structure of the ingredients database 43 of FIG. 4B is represented in FIG. 5A. The data stored in the ingredients database 43 are organized according to a hierarchy or levels. Each record is essentially a data structure, as is known in the art of computer science. This guarantees efficient access to the data by dedicated applications (for example the ingredients manager application 41 as described above). Since the products sold by the fast food store are categorized as meals, recipes or ingredients, conveniently the ingredients database 43 has also records representative of meals recipes and ingredients. In other words, the ingredients database 43 is structured in a way that reflects the way the store or restaurant is organized. This feature of the ingredients database will be clearer later.

At the top-most hierarchical level, the “meal” data structures or records 100 are found. Each record represents a “meal”, i.e. lists the individual components making up the meal. A “meal” record therefore reflects an order for a meal, as established by a user or purchaser of the system 2000. The “meal” records 100 is at the top-most hierarchical level in the ingredients database 43 since the meal records can comprise many items, for example cooked items (for example a soup), assembled items (a sandwich), beverage items (orange juice), dessert items, snack items, fruit pots etc . . . As it is evident, many combinations forming a meal can be stored at the “meal” level. The menu of the fast food outlet running the system 2000, which comprises many combinations of products for consumption (these combinations are often called meal deals in the fast food industry), can be represented in the ingredients database 43 at the “meal” level.

The second level in the data hierarchy is represented by a group of “recipe” records or data structures 110. Each record is representative of a food or beverage item or dish which is cooked, prepared, assembled or otherwise manipulated at the fast food outlet.

These records are particularly useful to represent individual dishes, as the name “recipe” suggests.

The third level in the data hierarchy is represented by a group of “ingredient” records 140. Each record represents an ingredient. The ingredient records are further divided into records representing compound ingredients 120 and records representing single ingredients 130. The difference between single and compound ingredients is that the latter category of ingredients requires cooking, or some sort of preparation, or manipulation, in-store, whereas the former category of ingredients is actually used raw (i.e. for example “as supplied”). It is important to notice that a distinction can in principle be drawn between compound ingredient records and recipe records, since the latter records are generally suitable for representing a finished item, i.e. ready for consumption, like a dish, as cooked, assembled or prepared in-store, whereas the former are generally suitable for representing an un-finished item, i.e. generally not ready for consumption without further preparation.

The distinction between compound and single ingredients, however, could be based on other than the nature or preparation of the physical ingredient. This distinction could also, conveniently, be based on how the restaurant sources the ingredient and on how the ingredient can be better represented or modeled in the ingredients database. For example, if a fast-food outlet uses caramelized red onions (in nature, a compound ingredient since it requires preparation, mixing etc . . . ) to prepare some of its dishes or food items, and if this ingredient is externally sourced (i.e. it comes ready to use from a supplier), this could be classified in the ingredients database 43 as a single ingredient rather than a compound ingredient. If, instead, caramelized red onions are produced or cooked in store, but are generally used as an ingredient for sandwiches, this ingredient will be better represented in the ingredients database 43 as a compound ingredient. If the fast food outlet intends to sell caramelized red onions as a side dish, then caramelized red onions could be represented in the ingredients database 43 as a recipe, rather than as a single ingredient. It is also not excluded that there may exists, in the ingredients database 43, two or even three different records for caramelized red onions: one in the recipe group, one in the compound ingredient group and perhaps one in the single ingredient group, if all three of them are necessary (this could be the case if the fast food serves caramelized red onions as a dish on its own and as an ingredient for its sandwiches, sometimes sourcing the ingredient externally and sometimes preparing the ingredient in-house).

The fourth level in the data hierarchy is represented by a pool of “attribute” records 150. Each attribute record represents a certain characteristic of an ingredient. If we consider one characteristic described by one attribute record of the attribute records 150, for example a “positive” attribute such as “containing uncooked meats”, this characteristic will be inherited by all recipes containing that ingredient and by all meals containing that recipe. The attribute records occupy the last level in the hierarchy of data, as they are not independent entities, i.e. they do not have a meaning unless they are associated with a record belonging to the ingredients group 140, as described above.

Further, it is clear that the nutritional values VN(i, k) as described hereinabove, are just a particular form of attributes, and attributes that will be inherited by the recipes and the meals in the same way as described above for the descriptive attribute “containing uncooked meats”. However, it is also clear that these nutritional values VN(i, k) will have to be used in conjunction with specified quantities of the ingredients, so that total nutritional values can be calculated as it has been illustrated in detail above.

FIG. 5B shows a tree diagram that illustrates the convenience and capability of the ingredients database. As explained before, the user of the system 2000 enters a proposed meal order. In the case of FIG. 5B, the proposed meal order entered by the user is represented by “My lunch” 101. “My lunch” is a preferred lunch combination of the purchaser and consists in this case of one Parma ham sandwich and a cup of orange and passion fruit juice. The “My lunch” combination could be already stored in one record in the meal group of the ingredients database 43, or it could be personal to the customer. Let us say that in this case the combination is already present in the database 43. In the ingredients database 43, the default value for the quantities for “sandwiches” and “juices” are one piece for “sandwiches” and one cup for “juices”. At the time of inputting a proposed order, the user has an opportunity to decide whether to place the order according to the default quantities, or whether he would like different quantities. Once the quantities of the proposed order are known, the FOOPE 50′, via the ingredients manager application 41′, interrogates the ingredients database 43. When the corresponding record is located, it is loaded into the FOOPE 50 for processing, according to any specified quantities. If the customer inputs a “My lunch” combination that is new, i.e. not stored already in the database, a new meal record 101 can be entered when the FOOPE 50 retrieves the recipes associated with the new “My lunch” combination. In this case the recipes would be a recipe 111 for the preparation of a Parma ham sandwich, and a recipe 112 for the preparation of a cup of orange and passion fruit juice. The new record could be entered automatically by the FOOPE 50′, via the ingredients manager application 41′, or it could be entered manually by a member of staff via the ingredients manager application 41′. The FOOPE 50′, in collaboration with the ingredients manager application/interface 41′, is then able to descend further into the hierarchic data structure of the ingredients database 43, since the recipes for the Parma ham sandwich and orange and passion fruit juice comprise ingredients. The Parma ham sandwich recipe record, for example, indicates that the sandwich is prepared with pita bread 131, caramelized red onions 121, Parma ham 132 and baby spinach 133. The FOOPE 50′ therefore accesses the records of these ingredients 131, 121, 132, 133. In the case of the compound ingredient needed for the preparation of the Parma ham sandwich, 50 grams of caramelized red onions 121, the FOOPE 50′ is further pointed to the records of the corresponding single ingredients forming said compound ingredient: salt 134, dark soft sugar 135, balsamic vinegar 136 and sliced red onions 137. The quantities of the single ingredients are inferred from the meal quantity imposed by the customer. For example, the quantities above would double if the user ordered two Parma ham sandwiches. The FOOPE 50′, in connection with the ingredients manager application 41′, follows a similar information-browsing path in the ingredients database for all the other items comprised in the meal.

When the FOOPE 50′ and the ingredient manager application 41′ have retrieved all the information regarding the combination “My lunch”, the FOOPE 50 will be ready to compute the overall output information regarding “My lunch” 173. The result of this computation is shown in FIG. 5B.

It should be noted that a number of possible information retrieval optimization strategies can be used by the ingredients manager application 41′. For example, following the creation of a new combination “My lunch” in the meal records, the results of the computation above could be stored in the “My lunch” record. If “My lunch” is requested again by a user of the system, the results of the computation of the FOOPE above 173 would therefore be readily available at “meal” level. If a new, unusual or personalized combination is entered by a customer, the system may be configured to store the new computation at “meal” level, or at “recipe” level. The offer of the fast food outlet can therefore be made even more flexible and still be accompanied with detailed information regarding the products ordered by customers. Preferred meal combinations, represented by corresponding records in the meal group 100 of the ingredients database 43, could form the fast food outlet's main menu, and could have ready nutritional information available at “meal” level. If, however, the customers want to customize their orders and still be able to get detailed information like the one that is pre-stored for each menu combination, they will be able to do so with this system 2000, due to the structure of the ingredients database 43.

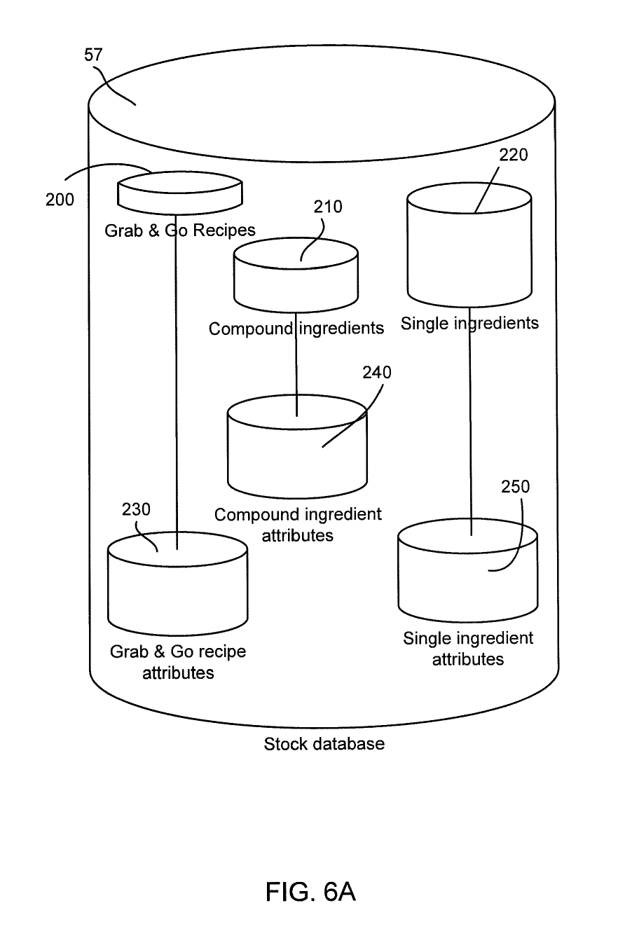

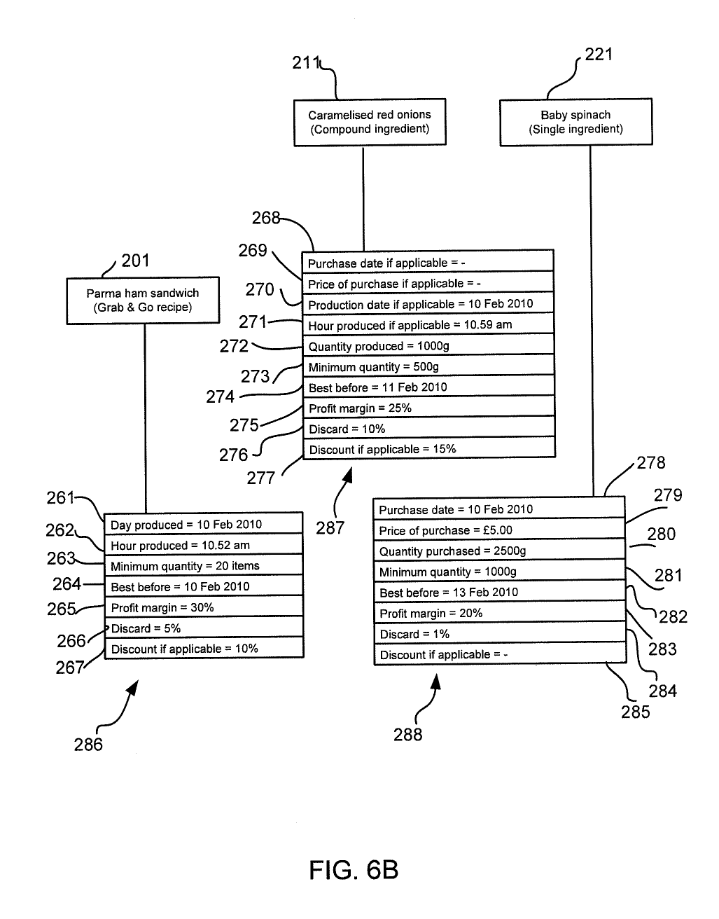

The structure of the stock database 57 of FIG. 4B is represented in FIG. 6A. The stock database 57 is intended to furnish a picture of the stock of all food and beverage items or products or meals, recipes and ingredients available in store and available for sale to customers of the fast food outlet running the system 2000.

There are three parallel groups of records, comprised in the stock database 57, respectively representing “grab&go” recipes (take-away units) 200, compound ingredients 210 and single ingredients 220. These are the three categories of stocked items according to the business model of the fast food outlet. However, it is clear that the stock database would be structured differently, if the restaurant kept different goods or product combinations in stock. Each group of records has an associated pool of attributes (230, 240, 250) that can be assigned to the records in order to reflect and describe the status of the stock of the ingredients or “grab&go” units kept in the store.

FIG. 6B represents the data structure of the records of FIG. 6A. We can see that the fast food outlet provides Parma ham sandwich recipes 201 on a “grab&go” basis. Each grab and go batch is described by a set of attributes. For example a stock of Parma hand sandwiches, stored in a “grab&go” refrigerator of the fast food outlet, is characterized by a “day produced” 261 attribute, a “hour of production” 262 attribute, a “minimum quantity” 263 attribute (which means a minimum number of pieces that should always be in stock i.e. ready to be grabbed by customers), a “best before” date attribute 264, a “profit margin” attribute 265 indicating how much profit is to be made for each sandwich to remunerate the operation of the preparation of the sandwich itself, a “discard” attribute indicating how much food is discarded due to the preparation of the sandwiches and a “discount” parameter indicating whether the stocked sandwiches should be offered at a reduced price (for example because the use by date is approaching). The fast food outlet also stocks compound ingredients, ready to be sold as such or as part of recipes made to order. Caramelized red onions 211 are one such ingredient. As it can be seen from FIG. 6B, the attributes describing the batch status are the “production date” 270, “production hour” 271, “quantity produced” 273, “minimum quantity” 273 of ingredient (that should always be present in-store), “best before” date 274, “profit margin” 275, “discard” 276 and “discount” 277. Since compound ingredients can be sourced externally, it will be possible to add the attributes of “purchase date” 268 and “price of purchase” 269, if caramelized red onions are sourced from an external supplier. Single ingredients will not be prepared in-store. They can only be sourced externally—for example ready-to-eat salads or leaves are single ingredients. As a consequence, any stored batch of a single ingredient can be described in term of the following attributes: “quantity purchased” 280, “minimum quantity” 281 of ingredient (that should always be present in-store), “best before” date 282, “profit margin” 283, “discard” 284, “discount” 285, “purchase date” 278 and “price of purchase” 279. Single ingredients will not be prepared in-store. Therefore, for this class of ingredients, the attribute “production date” will not be applicable.

The “profit margin” for a Parma ham sandwich (30%) is higher that that for caramelized red onions (25%), to account for the burden of the respective operations of preparation (greater when preparing a sandwich). This is why, for baby spinach, an ingredient that is just unpacked, washed and stored when it is received from a supplier, a “profit margin” of only 20% is used. It is also clear that the “discard” margin for baby spinach will be the lowest between the “discard” margins shown in FIG. 6B, since only a small part of the quantities of baby spinach received from the supplier will be wasted.

Moving back to FIG. 4B, it can now be explained how this system 2000 differs from the system previously described 1000.

It can first be noted that, in this arrangement 2000, the FOOPE 40′ and the BOOFE 50′ have been implemented on the same server 80. The ingredient manager application 41′ (which is here implemented on a different secondary computer, although this secondary computer is not shown in FIG. 4B) interfaces with the ingredients database 43 as well as the stock database 57. The ingredient manager application 41′ is therefore able to transmit to the server 80 preliminary information about the stock availability at the fast food outlet. This information can be made available to the purchaser at the moment when he wants to place an order, at the in-store user interface 36′ or the remote user interface 35′. Therefore, items, meals or ingredients that are not available, are made “invisible” to the purchaser, who cannot select any unavailable food or beverage meal, dish or ingredient. The BOOFE 50′ is connected to, and operates in conjunction with, a stock manager application 51′, which runs on a different secondary computer (the secondary computer is not shown in FIG. 4B). The stock manager application 51′ can access both the ingredients database 43 and the stock database 57. When the BOOFE 50′ receives an order that needs to be fulfilled, it transmits the order to one or more staff terminals. Upon the order being picked up by the staff for preparation and delivery, the BOOFE 50′ informs the stock manager application 51′ that the order is being fulfilled. The stock manager application 51′ thus accesses the records of the stock database associated with the order and updates the relevant fields to take into account that the meal, dishes or ingredients in the quantities specified in the order have or are going to be removed from the restaurant since they have been sold. Since the stock manager application 51′ is also connected to the ingredients database, which, as described before, contains information on how to cook a recipe or how to prepare a compound ingredient or assemble a certain meal, these various instructions can be made readily available to the staff of the fast food outlet when a certain stock needs to be created. Therefore, the connection and cooperation between the stock manager application and the ingredients database is an important feature of the “back-office” operations performed by the staff of the fast food restaurant.

The ingredient manager applications 41 and 41′ of the systems 1000, 2000 can be used by the staff or by administrators of the fast food restaurant to create meals, recipes and ingredients flexibly and conveniently. Once the system 2000 is in place, it will be easy for the restaurant to vary its menus, cuisine, recipes and meal deals. It will also be easy and convenient for the restaurant to monitor supplies and to assess the performance of suppliers. It is also clear that the system 2000 allows purchasers and users to be involved in the creation of personalized recipes. These can be stored in the ingredients database for other customer to use later.

The stock manager application 51′ is used by the staff of the fast food outlet to create, keep, monitor and maintain records of the stock of the shop. Since the stock records can be created down to the ingredient level, the restaurant will be able to manage the stock more efficiently. For example, the system 2000 can be used to monitor the popularity of a certain ingredient. If that ingredient is very popular with consumers, the stock can be increased. In other words, the system is able to operate flexibly and provides management tools for a tailored offer of food and beverage items. The system 2000 will also be capable of reacting quickly to any change of behavior of the consumers, as the recipes and stocks are easily re-defined.

Further advantages of the systems 1000, 2000 will be described below. We will now describe a typical consumer experience and vendor experience leading to a commercial transaction.

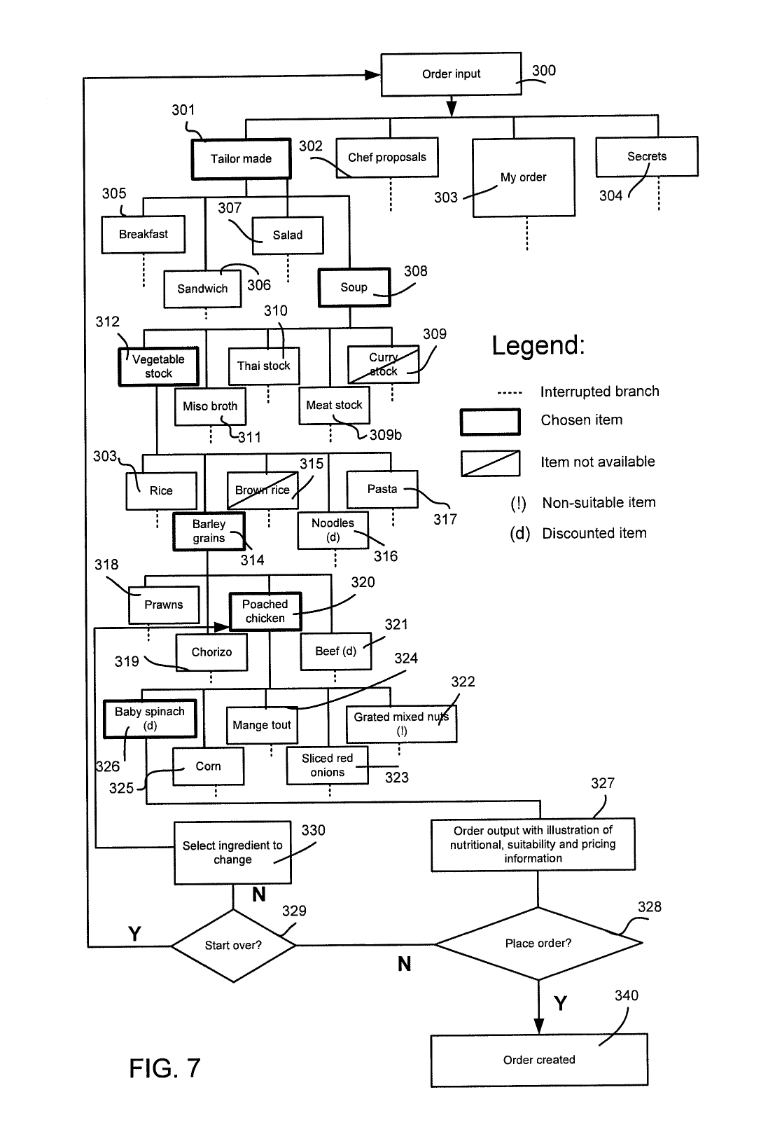

FIG. 7 is a flow diagram representing a method of ordering a dish using the system of FIG. 4B. When a consumer requires an order to be created 300, various options are given. In the “Tailor made” option 301, the consumer goes through a series of successive choices that allow him to build up a personalized dish or meal at the moment of ordering. In the “Chef proposal” option 302, the user can choose between a number of ready available combinations (meals). In the “My order” 303 option, the user can input a personalized request that was prepared earlier by the consumer and which is stored in a magnetic or loyalty card of the consumer. In the “Secret” option, the purchaser is allowed to buy only a subgroup of recipes or ingredients relative to certain typologies of food, like desserts and coffees. It is envisaged that with the system of the present invention 1000, 2000, a consumer would be able to decide which subgroup of items or recipes he wants to order from, for example only dishes containing “asparagus”. FIG. 7 illustrates a decision process based on the “Tailor made” option 301. The customer chooses what type of meal he would like to have, among a number of possible choices: breakfast 305, sandwich 306, salad 607 or soup 308. Each choice determines a path comprising further choices. In the second tier of choices, all relative to the previous choice of soup 308, the alternatives are: vegetable stock 312, miso broth 311, Thai stock 310, meat stock 309b and curry stock 309. The stock manager application 51′ has informed the customer that the curry stock is not available. Nevertheless, the user chooses the vegetable stock 312. The next tier of alternatives includes rice 313, barley grains 314, brown rice 315, noodles 316 and pasta 317. Brown rice is not in stock and the noodles are discounted. The user nevertheless prefers the barley grains 314 selection. The next tier of alternatives includes prawns 318, chorizo 319, poached chicken 320 and beef 321. Like above, the customer selects an item which is not discounted. The final round of alternatives includes baby spinach 326, corn 325, mange tout 324, sliced red onions 323 and grated mixed nuts 322. The consumer receives a warning that grated mixed nuts are not suitable for his diet, and this time he selects a discounted item, baby spinach. The “no grated nuts” requirement of the consumer was stored in the loyalty card, like the “My order” selection 303. The loyalty card can easily be read for example by one of the in-store terminals 36 of the system 1000.

Any consumer individual preferences defined individually by the consumers could be stored in media like magnetic fidelity cards (e.g. “low-calories meal avoiding cheeses”). Many other types of media (hence media/reader solutions) are however available. The readers would be supplied for example at the system terminals 36, as it is know in the art. For example, near field contact cards/readers could also be used. RFID technology could also be used. When sets of alternative choices are proposed in tiers like in FIG. 7, the system 1000, 2000 could therefore be designed to take into account any individual or personal user's requirement. The databases could therefore be interrogated while taking into account these personal requirements (e.g. excluding high calories ingredients and cheeses).

The system 1000, 2000 can be used in a “trial and error” fashion: the user proposes an order; information regarding the proposed order is fed back to the user/consumer; the consumer may wish to change the individual ingredients comprised in the order.

The system 1000, 2000 can be used in a “query” fashion: the user inputs certain requirements; solutions or choices are given to the consumer only if they satisfy the consumer requirements; and the consumer chooses his meal or unit for consumption. When the order is placed, the nutritional and/or other characteristics of the order are displayed, as explained previously.

In FIG. 7, it is possible to see how the consumer can make an informed decision about what he is about to eat or drink, as a whole meal, or about a sub-group of units belonging to the meal. If the consumer is not satisfied with the order entered, he can start the whole procedure over 329 or he can re-select an ingredient at any one of the tiers above 330. Eventually, an order is created 340.

The process illustrated in FIG. 7 is underpinned by the provision of an ingredients database 43 with the structure described above. Key elements of the system 2000 can be seen as: the “granularity” of the information about the composition of meals and recipes, down to the ingredient level, as represented in the ingredients database 43; and the interaction or cross-correlation of the information stored in that databases 43 with the information made available by the stock database 57.

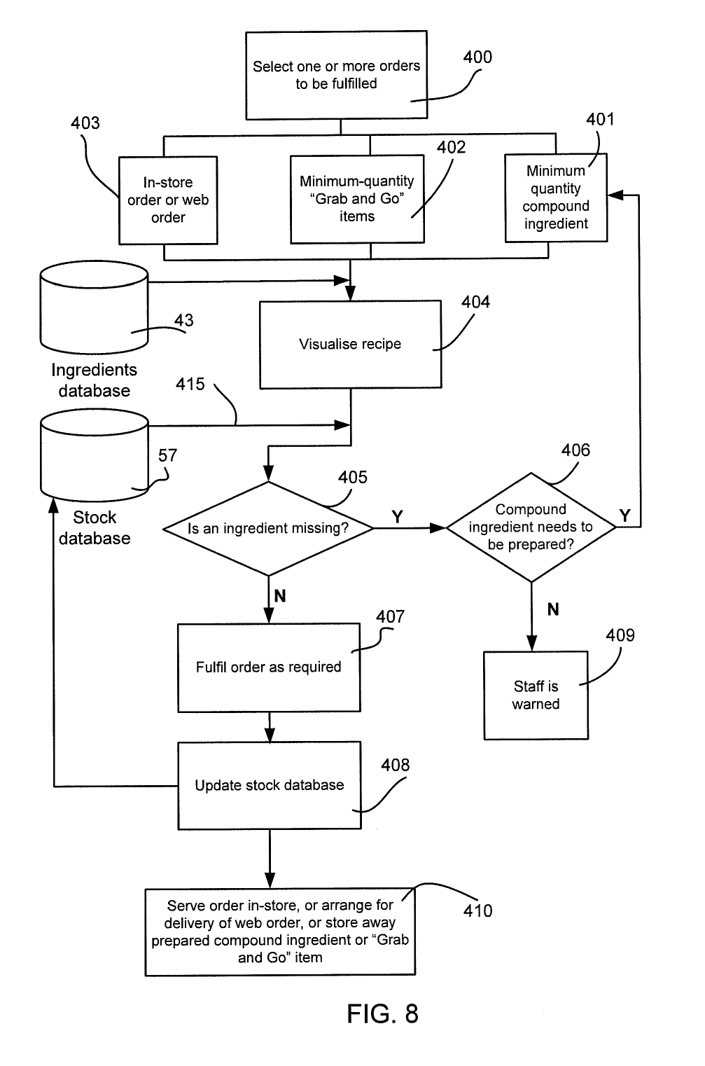

FIG. 8 is a flow diagram of a method of preparing a dish, meal or compound ingredient using the system of FIG. 4B. There are three categories of actions that the staff of the fast food restaurant can select to perform: the fulfillment of an in-store or web-derived customized order 403, the replenishment of a minimum quantity ingredient 401 or the replenishment of a minimum quantity “grab&go” stocked item. When the operator has selected the operation that he wants or must fulfill (it will be remembered that these are made available at the user terminals by the BOOFE 50′), the ingredients database 43 will provide all the necessary information about the sequence of actions to be performed according to a recipe 404. Although the stock may have been checked at the moment of placing the order, the diagram of FIG. 8 includes a further stock check operation 415, 405. In this way the operator is informed, or again informed, in the event that an ingredient is missing, i.e. is not in stock. If no ingredient is missing, the order proceeds to fulfillment 407 and the stock database 57 is updated. The order is then served or delivered 410. If an ingredient is missing, the case may be that a compound ingredient simply needs to be replenished to be able to fulfill an order. If this is the case, the requested operation is logged by the BOOFE 50′. If the compound ingredient is sourced from a supplier, the case may be that the only action possible is to inform the staff that an order needs to be placed with the supplier for the missing ingredient as soon as possible 409.

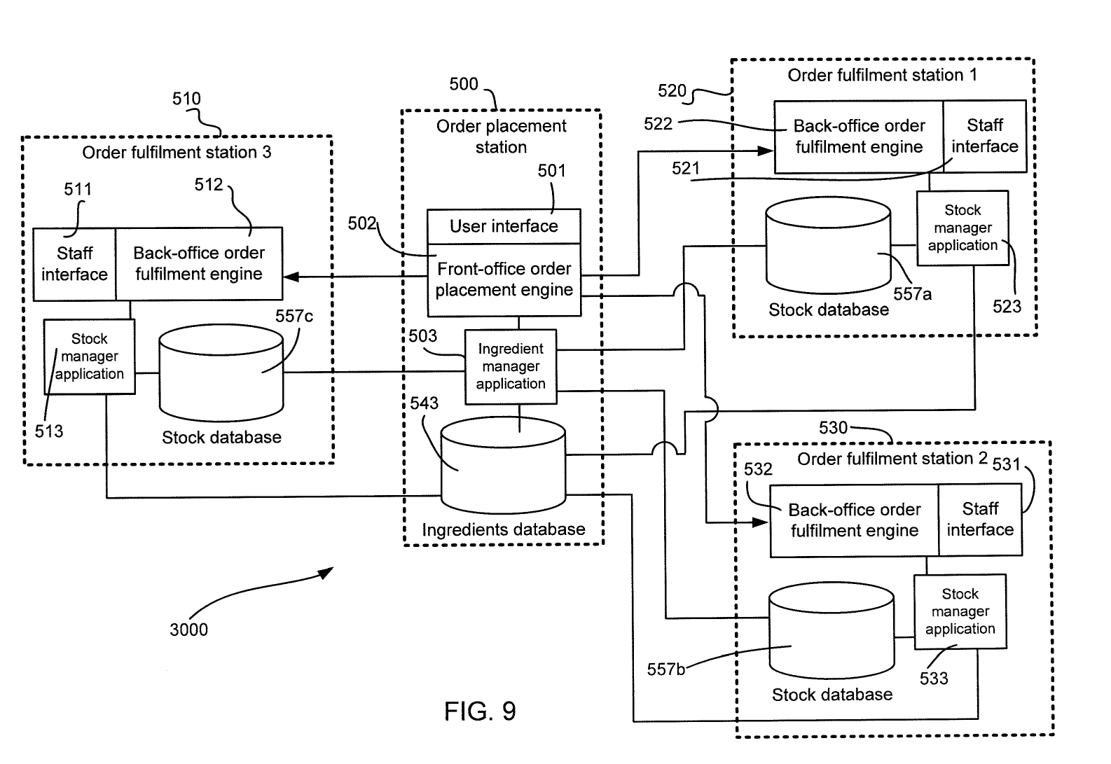

FIG. 9 is a schematic representation of a system 3000 with multiple food and beverages order fulfillment stations (OFSs) 510, 520, 530, all depending on a central food and beverages order placement station (OPS) 500.

The OPS comprises a user interface 501 for interaction with customers, a FOOPE 502, an ingredient manager application 503 and an ingredients database 543 of the kind described above.

Each OFS comprises a staff interface 511, 521, 231, a BOOFE 512, 522, 532 and a stock database 557a, 557b, 557c, again according to the corresponding stock databases described above. The ingredients manager application 503 is connected to the three stock databases 557a, 557b, 557c and the three stock manager applications 513, 133, 523 of respective OFSs 512, 520, 530 are connected to the central ingredients database.

In this way, an order can be placed centrally with the central ordering station 500 by placing the order through a user interface 501. The order is analyzed and output information is generated by the FOOPE 502 in collaboration with the ingredient manager application 503 and the ingredients database 543. In this embodiment, the user interface, the OPS and the ingredients database are implemented all on the same central ordering server. In the event that an order cannot be fulfilled based on the stock of one of the OFSs, the OPS will try to place the order with an alternative OFS that has informed the OPS that the order can be fulfilled. In case more than one OFS can fulfill the order, the central OPS is programmed to choose which OFS should be entrusted with the order. The choice may be based on criteria depending on the location of the user or, for example, on the age of the stock of perishable product, thereby making a cost saving.

FIG. 10 is an example of a screen 360 displayed at an in-store user terminal of the system of FIG. 4A. In this example, a customer has chosen to build his own salad, which is labeled “My Salad” 368. In the system database 42 of the system 1000 of FIG. 4A, there is a recipe record corresponding to “My Salad”. The recipe record contains sets of instructions for assembling or preparing the dish resulting from the final order of the customer. From FIG. 10 we can see that the Customer has not yet completed the order, but he is only at “Step 2” 359 out of a total of seven steps 369 required for completing the order. As discussed in the description of FIG. 7, the method of ordering “My Salad” 368 will have been programmed in the FOOPE server 60, and the program will cooperate with the ingredient manager application 41 which acts as an interface to the system database 42. The completed order will result in a “front-office” output, for the benefit of the customer, and in a “back-office” output, for the benefit of the staff of the fast food outlet operating the system 1000. The front office output will be described in detail below and is represented in FIG. 10. The back office output will consist in a set of instructions that allows any operator of the fast food outlet to easily prepare and build the personalized salad ordered by the customer. In addition, if there is available a stock database, like the one of the system 2000 of FIG. 4B, the operator of the fast food outlet will also be able to update the stock information based on the personalized order placed by the customer.

Before describing the so-called front office output of FIG. 10, the interaction of the customer with the in-store user terminal will be described. The screen 360 of FIG. 10 displays a number of available choices in relation to “Step 2” 357 of the ordering process. “Step 2” relates to the choice of ingredients predominantly bringing carbohydrates to the overall nutritional content of the salad. The screen is a touch-screen, and the customer can interact with it by means of a touch-screen cursor 358. The screen shows six carbohydrates choices: brown rice 361, pasta 362, pasta salad base 363, barley grains 364, rice noodles 365 and rice salad base 366. The customer has chosen pasta salad base 363, this choice being highlighted in FIG. 10. Each ingredient choice is accompanied by a respective quantity 373, 376, 379, 382, 385, 388. The ingredient quantities are adjustable by means of increment/decrement buttons 375, 378, 381, 384, 387, 390.

Returning to the front office output illustrated in FIG. 10, it will be noted that when the quantity of an ingredient is adjusted by the customer, a corresponding price for the quantity of ingredient is displayed. For example 60 grams 379 of pasta salad base will cost £1.32. More selections of ingredients 367 are also available, although not shown in FIG. 10. The customer can quickly compare prices 374, 376, 379, 385, 385, 388 of different quantities 373, 376, 379, 382, 385, 388 of different ingredients. He can adjust these quantities, and consequently the corresponding prices, for example having in mind a target o desired price. The interface 360 also shows the aggregated total cost 372 of the selections across the steps 369 necessary to build the personalized salad, in this case £3.52. The total calories 370 of the salad, as of “Step 2”, are also outputted. In addition, a special parameter called Food Secret Rating 371 is displayed. In this case this is a five star system of classifying a dish or a meal, according to a certain algorithm based on the nutritional, price and other characteristics of the ingredients comprised in the dish or meal. The screen interface 360 comprises also a graphical representation of the nutritional content of the current ingredient choices. The monitored nutritional parameters are in this case five: proteins 394, carbohydrates, 395, fiber 399, saturated fats and unsaturated fats. Male and female nutritional parameter reference values are expressed in percentage. In this case, the male 392 and female 391 nutritional parameter reference values are simply set to 100%. This percentage indicates the percentage of recommended intake for a meal, in this case lunch. Therefore, the customer will be able to compare, according to his/her sex, the nutritional content of the salad, as this is being ordered at the ordering point, in respect of recommendations relative to consuming the salad for lunch. Absolute reference values are not visualized in this embodiment, but that could be implemented. Since male and female customers will have different absolute recommended meal intake values, the graphical elements representing, as a percentage, the nutritional contents of the salad have different lengths. For example the length of the bar 398 representing the total proteins of the salad (as of “Step 2”) compared to the reference value for a male consumer 392, is different from the length of the corresponding bar 396 for a female consumer. The same can be said for the bars 397, 399 representing the fiber content of the salad and for the other bars illustrating the content of the other nutritional parameters, such as fats or carbohydrates. The interface 360 also contains an indication 355 of the suitability of the salad associated with a medical or taste condition of the customer. In this case, this indication 355 concerns the presence of any dairy products in the salad. The interface 360 shows that the salad is, so far, free form dairy products. If dairy products are not desired in the dish, step 5 will be by-passed.

The customer gathers information form the interface 360 and makes decisions based on this information. For example, a customer may want to bring the fiber content of the proposed salad within the reference limit 391, 392. The customer can do so by acting on the increment/decrement button 381 of the selected ingredient 363 to decrease the quantity of pasta salad base to be consumed, or he can remove his selection altogether and select a different ingredient.

The information to be provided by the front office output can be fully decided by the customer, or all or part of it can be decided by the fast food outlet. When customers are allowed to decide (wholly or partially) the information content to be displayed to them while they select the ingredients to be included in their dish or meal, they can do so taking into account their own taste requirements, for example a customer may not want to consume onions, or other requirements, for example a medical requirement such as an allergy given by a certain ingredient or type of food to be avoided.

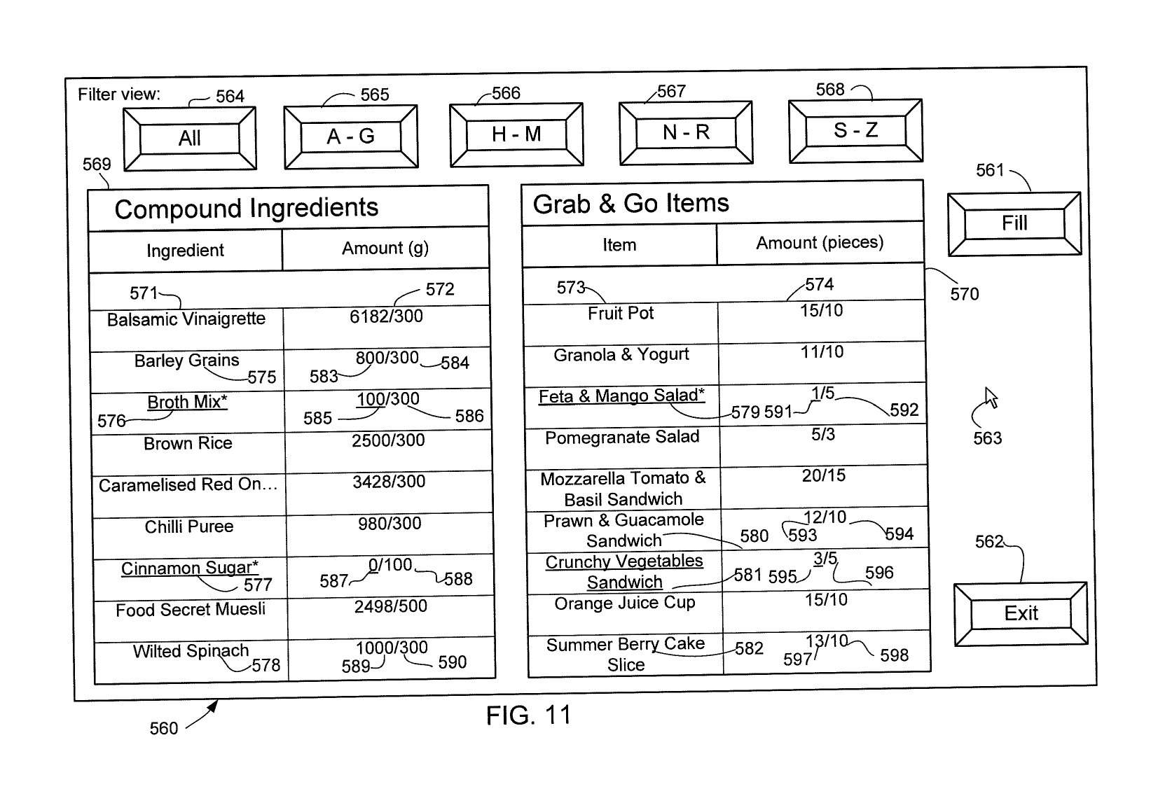

FIG. 11 is an example of a screen displayed at an in-store staff terminal of the system of FIG. 4B. A member of staff, an operator, can interact with the touch-screen via the cursor 563. He can filter the list of items displayed by the interface 560. To do this, there are provided filter buttons 564, 565, 566, 567, 568 to filter the ingredients alphabetically. In FIG. 11, two lists are shown: one relates to “compound ingredients” 569 and the other relates to “grab & go items” 570. As discussed for FIG. 8, and as seen for FIG. 10 above, the screen 560 can also comprise a list of made-to-order or personalized items such as “My salad” described above; in this case the staff interface 560 will show a list of “placed orders” in addition to the lists of “compound ingredients” and “grab & go items”.

In FIG. 11, it can be seen that the attention of the operator is drawn to a certain number of items which require action. The items requiring action 576, 577, 579, 581 are highlighted with an underline and a “star” symbol. All items of the list of “placed orders”, if this is included in the interface 560, would require action, i.e. the physical preparation of the ordered dish or meal. Returning to the embodiment illustrated in FIG. 11, when the operator decides to go ahead with an action, he will move the cursor 563 to select an ingredient or item requiring attention and will then press the “Fill” button 561 to receive information or instructions regarding actions to be performed in respect of the selected task. In particular, he will receive a recipe or a set of instructions for preparation and/or assemblage of the order. When the actions have been completed, he will return to the staff terminal and press the “Exit” button 562 to return to the screen 560 currently shown, so that the next task can be chosen. The selection of the tasks to be performed can be left to the initiative of the operator, or priority can be imposed on each task.

The staff interface 560 of FIG. 11 includes a list of compound ingredients 571 and a list of associated quantities 572. Reading from the list of associated quantities, it can be seen, for example, that there are currently 800 grams of barley grains 583 currently stocked at the fast food outlet. There is also indicated, in said list, a minimum amount of barley grains 584 that should be available for sale at any moment (300 grams). Minimum amounts of compound ingredients are ingredient attributes, as discussed above in relation to FIG. 6B. The “broth mix” ingredient 576 is currently available, but there are only 100 grams thereof 585 stocked. The interface 560 shows that 300 grams of broth mix 586 should always be available at the shop. Since the available quantity is lower that the minimum quantity, the “broth mix” ingredient is highlighted to indicate that action is required to replenish the quantity of available ingredient. Another ingredient, cinnamon sugar 577, has run out (a null quantity 587 is associated thereto). Its minimum quantity is 100 grams 588. When the operator has finished preparing, for example, 300 grams of cinnamon sugar, the amount currently available of cinnamon sugar will be updated by the operator in the stock database 57, via the stock manager application 51′, as described above. This new information will be visualized in the staff interface 560. Cinnamon sugar is very simple to prepare, as it requires cinnamon to be simply mixed with white sugar. A recipe says that 50 grams of cinnamon should be mixed with 250 grams of sugar to obtain 300 grams of cinnamon sugar. The recipe is stored in the ingredients database and is retrieved by the interface 560 via the ingredients manager application 41′. The recipe is visualized by the operator when he selects the cinnamon sugar ingredient 577 in the interface 560 of FIG. 11. The operator can input in the interface 560 that he is intending to prepare 300 grams of ingredient. When he has finished the preparation and hits the button “Exit”, the BOOFE 50′ will translate the action in an update of the stock database via the stock manager application 51′. In this case, 250 grams of sugar will be subtracted to the value of the record for the ingredient “white sugar”, and 50 grams will be subtracted to the value of the record for the ingredient “cinnamon”. “White sugar” and “cinnamon”, according to the definition of single and compound ingredients given hereinabove, are two single ingredients. Nevertheless, they will have minimum quantity values associated to their respective records in the stock database. This information could also be included in the staff interface 560, in an additional list of “Single ingredients”. Single ingredients will be replenished by regular supplier deliveries or special deliveries of single ingredients could be instigated by the operator. A single ingredient will not have a recipe or recipes associated, but could have a set of instructions to instigate delivery from a supplier (e.g. supplier contact and instructions on how to place an order). Wilted spinach 578 is available in sufficient quantity 589 (1000 grams), the minimum quantity thereof 590 being just 300 grams.

The staff interface 560 of FIG. 11 includes also a list of “grab & go items” 573 and a list of associated total quantities 574. In this case, as natural, the quantities of grab & go items are expressed in units or pieces rather than grams, as for the compound ingredients. Reading from the list of associated quantities, it can be seen, for example, that the prawn and guacamole sandwich 580 and the summer berry cake 582 are currently well stocked, with respectively 12 and 13 pieces 593, 597 available to be grabbed from the grab & go fridge of the fast food outlet (the minimum quantity is 10 pieces in either case 594, 598). There is only one feta and mango salad left 579, when its minimum quantity is five pieces 592. The operator should therefore soon prepare new units of feta and mango salad 579, and he will do so in the usual way, i.e. he will visualize a recipe and/or instructions from the ingredients database 43 and will then accordingly be updating the stock database via the BOOFE 50′ and stock manager application 51′. The crunchy vegetable sandwiches 581 are also below their minimum quantity 596 (five pieces): only three 595 are currently present in the fridge and therefore action is required from the operator as described above.

### DESCRIPTION OF ALTERNATIVE EMBODIMENTS

Reference has been made in the description above to dishes; however it is clear that wherever the term “dish” has been used, this could have been replaced by a more general definition such as “consumable unit”, which includes, for example, simple or mixed drinks or beverages.

With reference to FIG. 4A, the in-store user terminals could be replaced by a single in-store ordering kiosk equipped with a card reader. A customer of the fast food outlet will use a loyalty card in conjunction with the reader to interact with the system 1000. In particular, the customer's loyalty card will store information about a preferred meal of the customer and it can be used to order the meal in one single action, for example by swiping the card into the reader to upload an order into the system 1000. The loyalty card can also store personalized nutritional requirements of the user, for example a daily recommended intake of calories that has been prescribed by a doctor, or in relation with a medical condition of the customer. The information wanted by the customer is then retrieved by the FOOPE 40 in cooperation with the system database, as described before.

The ordering kiosk can be equipped with a label printer which can print a label with the information calculated or retrieved by the FOOPE. In this case, the customer will be able to stick a personalized label to the meal he ordered when the meal is delivered to him. The kiosk can therefore implement an order by order label printing service.

The concept of order by order label printing service can also be implemented directly at one of the terminals 35, by integrating a label printing machine with such terminals and therefore with the system.

It will also be possible for a customer to use the system of FIG. 4A as a computation tool, for example to analyze a proposed order, without necessarily finalizing the order.

With reference to FIGS. 4A and 4B, the ingredient manager application and the stock manager application can be accessible to the staff of the fast food outlet, or the access can be reserved to a manager of the fast food outlet if it is intended that the manager should be the only role who can create ingredients and recipes in the ingredients or system database or can alter the database records, for example by adding or removing any of the data structure fields describing the status of a certain stock of a single or compound ingredient, or of a “grab&go” meal.

In FIG. 5A, the pool of attributes of the ingredients database could also contain pricing records relative to specific quantities of ingredients. Discount information can also be included, for example to define that all meals including the ingredient “duck” should be discounted proportionally to the quantity of duck used. Therefore, a sandwich or a soup including duck as an ingredient will be discounted proportionally to the quantity of duck used for preparing them.

In FIG. 5B, the “My lunch” information output 173 has been calculated for the whole proposed meal 101. However, it would be possible to calculate an equivalent information output for a sub-group of ingredients or consumable units comprised in the meal 101. For example, an equivalent calculation could be performed for the Parma ham sandwich or orange and passion fruit juice only. Alternatively, if necessary, individual ingredients could be taken out from such calculation, for example Parma ham 132. The sub-group could be customer-defined—for example a customer could require that “calories” and “proteins” be calculated only for the food-items but not for the beverages included in a meal.

In FIG. 9, the three stock databases could be not connected to the ingredient manager application. This arrangement would be appropriate if any order fulfillment station will be able to fulfill any order irrespective of the status of their stock (for example a situation in which all ingredients are prepared to order and the supply of basic ingredients is constant).

In FIG. 10, the increment/decrement buttons could be absent, if the fast food outlet intends to offer only quantities of ingredients which are cannot be modified interactively by the customer.

It will be appreciated from the above that the system and method of the present invention obviates prior art drawbacks.

Although the present invention has been described hereinabove with reference to specific embodiments, it will be apparent to the skilled person in the art that modifications lie within the spirit and scope of the present invention.

What is claimed is:

1. A computerized method of ordering a meal in combination with calculation and comparison of nutritional values of the meal, the method comprising:
providing a database comprising records representative of:
a plurality of food or beverage items,
values of at least two nutritional principles associated with each food or beverage item of said plurality of food or beverage items for a reference amount of food or beverage item,
a plurality of consumable units, wherein at least one food or beverage item can be associated to each consumable unit of said plurality of consumable units;
using a user interface to receive a selection of at least one consumable unit from said plurality of consumable units in said database;
for each selected consumable unit, using a user interface to receive a user selection of at least one food or beverage item associated with the selected consumable unit, wherein a total of at least two food or beverage items are selected, and wherein each selected food or beverage item has an associated amount;
for each selected food or beverage item, using a processor to access said database to acquire at least two values of nutritional principles, the nutritional principles for which values are acquired corresponding to at least two monitor nutritional principles common to all the selected food or beverage items;
using the processor to calculate at least two total nutritional values, each total nutritional value being given by a summation of terms, each term corresponding to a selected food or beverage item and each term being calculated by multiplying an acquired value of a nutritional principle by an associated amount of selected food or beverage item;
using the user interface to display the total nutritional values; and
using the user interface to receive an order for the meal, the meal comprising the at least two selected food or beverage items.

2. A computerized method of ordering a meal as claimed in claim 1, wherein the database comprises values of at least three nutritional principles associated with each food or beverage item of said plurality of food or beverage items for a reference amount of food or beverage item, the method further comprising:
using the user interface to receive a selection of the at least two monitor nutritional principles.

3. A computerized method of ordering a meal as claimed in claim 1, further comprising using the user interface to visualize a graphical element representative of the total nutritional values of the selection of food or beverage items.

4. A computerized method of ordering a meal as claimed in claim 3, wherein said graphical element comprises at least two shapes, each shape defining an area delimited by a perimeter, wherein each area of each shape is associated with a total nutritional value.

5. A computerized method of ordering a meal as claimed in claim 4, wherein each area of each shape changes as a function of the associated total nutritional value.

6. A computerized method of ordering a meal as claimed in claim 5, wherein the area of each shape of said graphical element changes linearly with the associated total nutritional value.

7. A computerized method of ordering a meal as claimed in claim 4, wherein the at least two shapes of said graphical element are grouped close to each other, a gap being provided between each pair of perimeters of said at least two shapes.

8. A computerized method of ordering a meal as claimed in claim 7, wherein a value measuring said gap is less than one fifth of the value of the perimeter of the shape with the smallest area.

9. A computerized method of ordering a meal as claimed in claim 4, wherein an acronym representative of a nutritional principle is displayed within an associated perimeter.

10. A computerized method of ordering a meal as claimed in claim 4, wherein the database further comprises records representative of target nutritional values for the monitor nutritional principles, the method further comprising:
using the user interface to output the target nutritional values.

11. A computerized method of ordering a meal as claimed in claim 10, further comprising:
for at least one selected consumable unit, using the user interface to confirm or cancel the selection of at least one selected food or beverage item, or to confirm or modify at least one amount of selected food or beverage item.

12. A computerized method of ordering a meal as claimed in claim 10, further comprising:
using the user interface to output an alert signal, if a total nutritional value is higher than a corresponding target nutritional value.

13. A computerized method of ordering a meal as claimed in claim 12, wherein the alert signal is obtained by causing a shape of the graphical element associated with a total nutritional value higher than a target nutritional value to flash with a preset frequency and create a blinking effect.

14. A computerized method of ordering a meal as claimed in claim 1, wherein the user interface is implemented onto a purchaser touch-screen terminal.

15. A computerized apparatus for ordering a meal and calculating nutritional values of the meal, the apparatus comprising:
a database;
a processor connected to said database;
an input device connected to said processor; and
an output device connected to said processor;
wherein the database comprises records representative of:
a plurality of food or beverage items comprised in the meal;
values of at least two nutritional principles associated with each food or beverage item of said plurality of food or beverage items for a reference amount of food or beverage item;
a plurality of consumable units, wherein at least one food or beverage item can be associated to each consumable unit of said plurality of consumable units;
wherein the input device is configured to receive a selection comprising at least one consumable unit comprising at least one food or beverage item of said plurality of food or beverage items, wherein at least two food or beverage items are selected, and is configured to transmit said selection to the processor for processing;
wherein the processor:
is programmed to receive said selection,
is programmed to access said database to acquire at least two values of nutritional principles for each food or beverage item comprised in the selection,
the nutritional principles for which values are acquired corresponding to monitor nutritional principles common to all the selected food or beverage items,
is programmed to calculate at least two total nutritional values, each total nutritional value being given by a summation of terms, each term corresponding to a food or beverage item and each term being given by multiplying an acquired value by a corresponding amount of food or beverage item, and
is programmed to output the total nutritional values to the output device;
wherein the output device is configured to display the total nutritional values; and
wherein the input device is operable to receive an order for the meal, the meal comprising at least two selected food or beverage items.

16. A computerized apparatus as claimed in claim 15, wherein the database comprises values of at least three nutritional principles associated with each food or beverage item of said plurality of food or beverage items for a reference amount of food or beverage item, and wherein the input device is further configured to receive a selection of the at least two monitor nutritional principles.

17. A computerized apparatus as claimed in claim 15, wherein the processor is further programmed to generate a graphical element representative of the total nutritional values of the selection of food or beverage items, and is programmed to transmit said graphical element to the output device, and wherein the output device is configured to display the graphical element.

18. A computerized apparatus as claimed in claim 17, wherein the graphical element comprises at least two shapes, each shape defining an area delimited by a perimeter, wherein each area of each shape is associated with a total nutritional value.

19. A computerized apparatus as claimed in claim 15, wherein the database further comprises records representative of target nutritional values for the monitor nutritional principles, wherein the processor is further programmed to acquire from said database the target nutritional values corresponding to the monitor nutritional principles and to send to the output device the acquired target nutritional values, and wherein the output device is further configured to output the target nutritional values.

20. A computerized apparatus as claimed in claim 19, wherein the processor is further programmed to generate an alert if a total nutritional value is higher than a target nutritional value, and is further programmed to transmit said alert to the output device, and wherein the output device is further configured to output said alert.

21. A computerized apparatus as claimed in claim 15, wherein either or both the input device; and
the output device;
is or are implemented on a touch-screen terminal.

22. A computerized food and beverages ordering apparatus for implementing an ordering service for meeting nutritional requirements of purchasers, the apparatus comprising:
a database comprising records representative of a plurality of ingredients, wherein at least two attributes are associated with each ingredient, one of the at least two attributes being a nutritional parameter for a specific amount of ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user;
a user interface operable by, or under the instruction of, a purchaser to receive an order for a meal, the meal comprising one or more of said plurality of ingredients, each ordered ingredient having an associated quantity; and
an order placement engine connected to said user interface and to said database, the order placement engine configured to send to an output user interface at least two output parameters, one of the at least two output parameters being a total nutritional parameter computed from the or a total quantity of respectively the or an ingredient comprised in the meal, and another output parameter of the at least two output parameters being a personal parameter.

23. A computerized food and beverages ordering apparatus as claimed in claim 22, the apparatus further comprising the output user interface and wherein the user interface and the output user interface are integrated into an input/output user interface.

24. A computerized food and beverages ordering apparatus as claimed in claim 23, wherein the input/output user interface is implemented onto a touch-screen terminal.

25. A computerized food and beverages ordering apparatus as claimed in claim 24, further comprising a staff user interface connected to said touch-screen terminal and configured to receive the order for the meal.

26. A computerized food and beverages ordering apparatus as claimed in claim 25,
wherein the database further comprises a record representative of the meal, said record comprising a set of instructions for preparing the meal by cooking, or assembling, or preparing the ingredients comprised in the meal in any other way, and the apparatus further comprising:
an order fulfilment engine connected to the database and configured for retrieving said set of instructions from the database;
wherein the staff user interface is connected to said order fulfilment engine to receive said set of instructions for preparing the meal, and is configured to output the order for the meal and corresponding set of instructions to operators of the food and beverages ordering apparatus.

27. A computerized food and beverages ordering apparatus as claimed in claim 26, the apparatus further comprising:
a stock database comprising records representative of ingredients, each record comprising a value representative of a stocked total quantity of respective ingredient available to be ordered,
wherein the stock database is connected to the user interface, and
wherein each associated total quantity of each ingredient comprised in the meal is comprised in the stocked total quantity of corresponding ingredient.

28. A computerized food and beverages ordering apparatus as claimed in claims 26, the apparatus further comprising:
a stock database comprising records representative of ingredients, each record comprising a value representative of a stocked total quantity of respective ingredient available to be ordered,
wherein the stock database is connected to the user interface, and to the order fulfilment engine,
wherein each associated total quantity of each ingredient comprised in the meal is comprised in the stocked total quantity of corresponding ingredient, and
wherein the order fulfilment engine is configured to update, in the stock database, at least one value representative of a stocked total quantity of an ingredient comprised in the meal.

29. A computerized food and beverages ordering apparatus as claimed in claim 28, wherein the order fulfilment engine is configured to perform the update of the at least one value representative of a stocked total quantity of an ingredient comprised in the meal by subtracting therefrom the associated total quantity of corresponding ingredient.

30. A user interface operable by, or under the instruction of, a purchaser to receive an input of an order for a meal, the user interface for use with:
a database comprising records representative of a plurality of ingredients comprising each ingredient comprised in the meal, the meal comprising at least one ingredient, each ingredient having an associated quantity, wherein at least two attributes are associated with each ingredient, one of the at least two attributes being a nutritional parameter for a specific amount of each ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user; and
the user interface for use with an order placement engine connected to the database and configured to retrieve at least one output parameter in response to an order for a meal, each output parameter being a total nutritional parameter calculated from each quantity of ingredient comprised in the meal and respective nutritional parameter for a specific amount of ingredient stored in said database, or a personal parameter,
wherein the user interface is configured to transmit the order for the meal to the order placement engine, is configured to receive from the order placement engine at least one output parameter, and is configured to output to the purchaser each output parameter, and
wherein the user interface is configured to receive a confirmation or modification of the order for the meal in response to the output to the purchaser of each output parameter.

31. A user interface as claimed in claim 30, wherein the user interface is configured to receive a selection of at least one desired output parameter, each desired output parameter being a total nutritional parameter computed from each quantity of ingredient comprised in the meal and from respective nutritional parameter for a specific amount of ingredient stored in said database, or a personal parameter, is configured to transmit to the order placement engine a request of each desired output parameter, is configured to receive from the order placement engine each desired output parameter and is configured to output to the purchaser each desired output parameter; and
wherein the user interface is configured to receive a confirmation or modification of the order for the meal in response to the output to the purchaser of each desired output parameter.

32. A user interface as claimed in claim 31, wherein the database further comprises records representative of a plurality of values of purchaser target output parameters, each purchaser target output parameter being associated with a respective output parameter, and wherein the user interface is further configured to receive back from the order placement engine a value of a purchaser target output parameter for each selected desired output parameter, and is configured to output to the purchaser each value of each received purchaser target output parameter, and wherein the user interface is configured to receive a confirmation or modification of the order for the meal in response to the output to the purchaser of each value of each purchaser target output parameter.

33. A user interface as claimed in claim 32, for use also with:
a card reader and a purchaser loyalty card,
wherein at least one among:
the order for the meal,
a desired output parameter, and
a value of a purchaser target output parameter,
is stored in the purchaser card, and
wherein the interface is configured to receive an upload from the card reader of at least one among:
the order for the meal,
a desired output parameter, and
a value of a purchaser target output parameter.

34. A user interface as claimed in claim 30 for use also with:
a stock database comprising records representative of ingredients, each record comprising a value representative of a stocked total quantity of respective ingredient available to be ordered,
wherein the user interface is further connected to the stock database and is further operable by, or under the instruction of, a purchaser to receive up to a maximum total quantity of each ingredient comprised in the meal, each maximum total quantity being comprised in the stocked total quantity of corresponding ingredient in the stock database.

35. A computerized method of ordering food and beverages according to personal requirements, the method comprising:
providing a database comprising records representative of a plurality of ingredients, wherein at least two attributes are associated with each ingredient, one of the at least two attributes being a nutritional parameter for a specific amount of each corresponding ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user;
using a user interface to receive a proposed order for a meal, the meal comprising one or more ingredients, each ingredient having an associated quantity;
using the user interface to select at least one desired output parameter, the desired output parameter being a total nutritional parameter computed from each quantity of ingredient comprised in the meal and from respective nutritional parameter for a specific amount of ingredient stored in the database, or a personal parameter;
using an ordering processor to retrieve information about the proposed order, said information comprising at least the desired output parameter and to output said information to the user interface.

36. A computerized method of ordering food and beverages according to claim 35, further comprising:
using the user interface to receive a change in at least one ingredient in the proposed order;
using the ordering processor to retrieve information about the proposed order based on the changed proposed order;
using the ordering processor to output said information about the changed proposed order to the user interface; and
transmitting the proposed order or the changed proposed order to a staff user interface for fulfilment of the transmitted order.

37. A computerized food and beverages preparation station for preparing a meal, the meal comprising one or more ingredients, each ingredient having an associated quantity, the station comprising:
a meal preparation unit comprising quantities of a plurality of ingredients and equipment required for preparing meals, said quantities comprising each quantity of each ingredient comprised in the meal,
a database comprising records representative of said quantities of a plurality of ingredients stocked at the meal preparation unit, and records representative of recipes, each recipe comprising a set of instructions for preparing a meal, said recipe records comprising at least one record representative of a recipe for preparing the meal; and
a meal preparation engine, the meal preparation engine connected to the database, and configured to output a recipe for the meal to a staff user interface for an operator of the meal preparation unit, wherein each record representative of each quantity of each ingredient comprised in the meal is configured for being updated in the database by the meal preparation engine when the meal is prepared at the meal preparation unit.

38. A computerized food and beverages preparation station as claimed in claim 37, wherein the database further comprises records representative of an expiry time of said quantities of a plurality of ingredients stocked at the meal preparation unit, and wherein the meal preparation engine is further configured to output an alert to the staff user interface for an operator of the meal preparation unit when at least one ingredient comprised in the meal is expired.

39. A computerized food and beverages preparation station as claimed in claim 37, wherein the database further comprises records representative of minimum quantities of said quantities of a plurality of ingredients stocked at the meal preparation unit, and wherein the meal preparation engine is further configured to generate a replenishment order and to output said replenishment order to the staff user interface for an operator of the meal preparation unit when a quantity of an ingredient of said plurality of ingredients stocked at the meal preparation unit is below an associated minimum quantity.

40. A computerized food and beverages preparation station as claimed in claim 37, wherein the database further comprises records representative of an expiry time of said quantities of a plurality of ingredients stocked at the meal preparation unit, wherein the database further comprises records representative of minimum quantities of said quantities of a plurality of ingredients stocked at the meal preparation unit, and wherein the meal preparation engine is further configured to generate a replenishment order and to output said replenishment order to the staff user interface for an operator of the meal preparation unit when:
at least one ingredient comprised in the meal is expired; or
when a quantity of an ingredient of said plurality of ingredients stocked at the meal preparation unit is below an associated minimum quantity.

41. A computerized food and beverages ordering and preparation apparatus for ordering and preparing a meal, the apparatus comprising:
a meal preparation unit comprising quantities of a plurality of ingredients and equipment required for preparing meals;
a database comprising records representative of said quantities of a plurality of ingredients stocked at the meal preparation unit, and records representative of recipes, each recipe comprising a set of instructions for preparing a meal, said recipe records comprising at least one record representative of a recipe for preparing the meal, wherein at least one attribute is associated with each ingredient of said plurality of ingredients, each attribute being a nutritional parameter for a specific amount of ingredient, or a personal parameter, said personal parameter being:
a parameter capable of describing the suitability of each ingredient associated with a medical condition of a user; or
a parameter capable of describing the suitability of each ingredient associated with a taste requirement of a user,
the apparatus further comprising:
a user interface operable by, or under the instruction of, a purchaser to input an order for the meal, the meal comprising one or more stocked ingredients, each ordered ingredient having an associated quantity comprised in the quantities of the plurality of ingredients stocked at the meal preparation station;
an order placement engine connected to said user interface for receiving the order for the meal and connected to said database, the order placement engine configured to send to an output user interface at least one output parameter, each output parameter being a total nutritional parameter computed from each total quantity of each stocked ingredient comprised in the meal, or a personal parameter; and
a meal preparation engine, the meal preparation engine connected to the database, and configured to send a recipe for the meal to a staff user interface for an operator of the meal preparation unit, wherein each record representative of each quantity of each ingredient comprised in the meal is updated in the database by the meal preparation engine when the recipe for the meal is sent to the staff user interface.

42. A computerized food and beverages ordering and preparation apparatus as claimed in claim 41, wherein the records representative of the quantities of stocked ingredients are updated in the database by subtracting the value of each total quantity of each ingredient comprised in the meal from the value of the quantity of the corresponding ingredient stoked at the meal preparation station.

43. A computerized food and beverages ordering and preparation apparatus as claimed in claim 41, wherein the user interface and the output interface are integrated into an input/output interface.

44. A computerized food and beverages ordering and preparation apparatus as claimed in claim 41, wherein the database further comprises records representative of an expiry time of said quantities of a plurality of ingredients stocked at the meal preparation unit, and wherein the user interface is operable to receive an order for the meal, the meal comprising one or more stocked ingredients having an expiry time later than a time when the order for the meal is transmitted from the user interface to the order placement engine.

45. A computerized food and beverages ordering and preparation apparatus as claimed in claim 43, further comprising the staff user interface, the staff user interface being connected to said input/output interface and configured to receive the order for the meal.

46. A user interface operable by, or under the instruction of, an operator of a meal preparation station to process an order for a meal, the user interface for use with:
a database comprising records representative of a plurality of quantities of ingredients stocked at the meal preparation station, said records comprising at least one record representative of one quantity of one ingredient stocked at the meal preparation station and comprised in the ordered meal, the ordered meal comprising at least one ingredient, each ingredient having an associated quantity, and the ordered meal comprising at least one ingredient stocked at the meal preparation station, and records representative of recipes, each recipe comprising a set of instructions for preparing a meal, wherein at least one record of recipe comprises a set of instructions for preparing the ordered meal;
a meal preparation engine connected to the user interface and connected to said database, the meal preparation engine configured for receiving the order for the meal, and configured to retrieve from the database a recipe for the ordered meal and to update in the database each quantity of each stocked ingredient comprised in the meal;
wherein the user interface, in response to a command from the operator to process the order for the meal, is configured to transmit the order for the meal to the meal preparation engine, and is configured to receive, in response thereto, from the meal preparation engine, a recipe for the meal and to display the received recipe to the operator of the meal preparation station, and
wherein each record representative of a quantity of a stocked ingredient comprised in the meal is updated in the database by the meal preparation engine when the ordered meal is processed.

47. A user interface as claimed in claim 46, wherein the database further comprises at least one record representative of an expiry time of a quantity of a stocked ingredient comprised in the meal, and wherein the meal preparation engine is further configured to output, in response to the receipt of the order for the meal, an alert to the user interface when at least one stocked ingredient comprised in the meal is expired, wherein the user interface is configured to receive and output the alert in response to the transmission of the order for the meal to the meal preparation engine.

48. A user interface as claimed in claim 46, wherein the database further comprises a record representative of a minimum quantity of ingredient and a record representative of instructions for replenishing said minimum quantity of ingredient for each record of a quantity of ingredient stocked at the meal preparation station, and wherein the meal preparation engine is further configured to generate a replenishment order and to transmit said replenishment order to the user interface for the operator of the meal preparation station when a quantity of an ingredient stocked at the meal preparation station is below an associated minimum quantity, wherein the user interface is configured to receive said replenishment order and, in response to a command from the operator to process the replenishment order, is configured to transmit the replenishment order to the meal preparation engine, and is configured to receive, in response thereto, from the meal preparation engine, the associated instructions for replenishing said below-minimum quantity of stocked ingredient.

49. A user interface as claimed in claim 46, wherein the database further comprises a record representative of an expiry time of a quantity of ingredient for each record of a quantity of ingredient stocked at the meal preparation station, wherein the database further comprises a record representative of a minimum quantity of ingredient and a record representative of instructions for replenishing said minimum quantity of ingredient for each record of a quantity of ingredient stocked at the meal preparation station, and wherein the meal preparation engine is further configured to generate a replenishment order and to transmit said replenishment order to the user interface for the operator of the meal preparation station when:
at least one ingredient comprised in the meal has expired; or
when a quantity of an ingredient stocked at the meal preparation station is below an associated minimum quantity,
an wherein the user interface is configured to receive said replenishment order and, in response to a command from the operator to process the replenishment order, is configured to transmit the replenishment order to the meal preparation engine, and is configured to receive, in response thereto, from the meal preparation engine, the associated instructions for replenishing said below-minimum or expired quantity of stocked ingredient.

50. A computerized method of processing an order for a meal, the method comprising:
providing a user interface and using the user interface to receive the order for the meal, the meal comprising at least one ingredient, each ingredient having an associated quantity;
providing a meal preparation station comprising quantities of a plurality of ingredients and equipment required for preparing meals, said quantities comprising each quantity of each ingredient comprised in the meal;
providing a database connected to said user interface comprising records representative of the plurality of quantities of ingredients stocked at the meal preparation station, and records representative of recipes, each recipe comprising a set of instructions for preparing a meal, said recipe records comprising at least one record representative of a recipe for preparing the meal;
providing an order fulfilment processor connected to said database and connected to said user interface, the order fulfilment processor configured to receive the order for the meal, configured to retrieve from said database said recipe for the meal, and configured to update in said database each record of each stocked ingredient comprised in the meal;
using the user interface to transmit said order for the meal to the order fulfilment processor;
using the order fulfilment processor to retrieve said recipe for the meal;
using the user interface to visualize said recipe;
preparing the meal according to said visualized recipe; and
using the order fulfilment processor to update in the database the record or records representative of the quantity or quantities of the stocked ingredient or ingredients comprised in the meal after the order for the meal has been transmitted to the order fulfilment processor.

51. A computerized method as claimed in claim 50, wherein the database further comprises a record representative of an expiry time for each quantity of said quantities of a plurality of ingredients stocked at the meal preparation station, and the method further comprising:
using the order fulfilment processor to output an alert when at least one quantity of ingredient comprised in the meal is expired.

52. A computerized method as claimed in claim 50, wherein the database further comprises a record representative of a minimum quantity for each quantity of said quantities of a plurality of ingredients stocked at the meal preparation unit, the method further comprising:
using the order fulfilment processor to generate a replenishment order when at least one quantity of an ingredient stocked at the meal preparation station is below an associated minimum quantity; and
using the order fulfilment processor to output said replenishment order to the user interface;
using the user interface to receive said replenishment order and to output said replenishment order.

53. A computerized method as claimed in claim 50, wherein the database further comprises a record representative of an expiry time of a quantity of ingredient for each of said quantities of a plurality of ingredients stocked at the meal preparation unit, wherein the database further comprises records representative of a minimum quantity for each quantity of ingredient stocked at the meal preparation station, the method further comprising:
using the order fulfilment processor to generate a replenishment order when at least one quantity of an ingredient stocked at the meal preparation station is below an associated minimum quantity or when at least one quantity of ingredient stocked at the meal preparation station is expired;
using the order fulfilment processor to output said replenishment order to the user interface;
using the user interface to receive said replenishment order and to output said replenishment order.

54. A computerized method of ordering and preparing a meal according to personal requirements, the method comprising:
providing an ingredients database comprising records representative of a plurality of ingredients, wherein at least two attributes are associated with each ingredient, one of the at least two attributes being a nutritional parameter for a specific amount of each corresponding ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user;
providing a user interface and using the user interface to receive an input of a proposed order for a proposed meal, the proposed meal comprising one or more proposed ingredients, each ingredient having an associated proposed quantity;
providing an ordering processor connected to said interface and to said ingredients database;
transmitting the proposed order for the proposed meal to the ordering processor;
using the ordering processor to generate information about the proposed meal, said information comprising at least one output parameter, said output parameter being a total nutritional value computed from at least one quantity of proposed ingredient comprised in the proposed meal and from respective nutritional parameter for a specific amount of ingredient, or a personal parameter;
using the ordering processor to transmit said information about the proposed meal to the user interface;
using the user interface to visualize said information;
providing a meal preparation station comprising quantities of a plurality of ingredients and equipment required for preparing meals, said quantities comprising each quantity of ingredient comprised in the meal, the meal comprising at least one ingredient, each ingredient having an associated quantity;
providing a stock database connected to said user interface and comprising records representative of the plurality of quantities of ingredients stocked at the meal preparation station, and records representative of recipes, each recipe comprising a set of instructions for preparing a meal, said recipe records comprising at least one record representative of a recipe for preparing the meal;
providing an order fulfilment processor connected to said stock database and connected to said user interface, the order fulfilment processor configured to receive the order for the meal, configured to retrieve from said stock database said recipe for the meal, and configured to update in said database each record of each stocked ingredient comprised in the meal;
using the user interface to receive an input to finalize the proposed order for the proposed meal into an order for the meal and transmitting said meal order to the order fulfilment processor;
using the order fulfilment processor to retrieve said recipe for the meal;
providing a staff user interface and using the staff user interface to visualize said recipe for the meal;
preparing the meal according to said visualized recipe; and
using the order fulfilment processor to update in the database the record or records representative of the quantity or quantities of the stocked ingredient or ingredients comprised in the meal after the order for the meal has been transmitted to the order fulfilment processor.

55. A computerized method as claimed in claim 54, the method further comprising:
using the user interface to receive a selection of at least one desired output parameter, the desired output parameter being a total nutritional parameter generated by the ordering processor from each quantity of ingredient comprised in the proposed meal and from respective nutritional parameter for a specific amount of ingredient, or a personal parameter;
transmitting said selection to the ordering processor;
using the ordering processor to generate each desired output parameter and to output each desired output parameter to the user interface; and
using the user interface to display each desired output parameter.

56. A computerized food and beverages label printing apparatus for producing personal labels for a meal, the apparatus comprising:
a database comprising records representative of a plurality of ingredients, wherein at least one attribute is associated with each ingredient, each attribute being a nutritional parameter for a specific amount of each ingredient or a personal parameter, said personal parameter being:
a parameter capable of describing the suitability of each ingredient associated with a medical condition of a user; or
a parameter capable of describing the suitability of each ingredient associated with a taste requirement of a user,
a user interface operable by, or under the instruction of, a purchaser to receive an order for the meal, the meal comprising one or more ingredients, each ingredient having an associated quantity;
a printing processor connected to said user interface and to said database, the printing processor configured to transmit to a label printer at least one printing parameter, each printing parameter being a total nutritional parameter computed from at least one quantity of ingredient comprised in the meal and from respective nutritional parameter for a specific amount of ingredient, or a personal parameter; and
a label printer connected to said printing engine, the label printer configured to print each output parameter.

57. A computerized food and beverages label printing apparatus as claimed in claim 56, further comprising a card reader for use with a purchaser loyalty card, wherein at least one between:
the order for the meal, and
a printing parameter,
is stored in the purchaser card, and wherein the card reader is configured to upload at least one between:
the order for the meal, and
a printing parameter,
to the user interface.

58. A method of printing a personalized label for a meal, the method comprising:
providing a database comprising records representative of a plurality of ingredients, wherein at least one attribute is associated with each ingredient, each attribute being a nutritional parameter for a specific amount of each ingredient or a personal parameter, said personal parameter being:
a parameter capable of describing the suitability of each ingredient associated with a medical condition of a user; or
a parameter capable of describing the suitability of each ingredient associated with a taste requirement of a user,
receiving via a user interface an order for the meal, the meal comprising one or more ingredients, each ingredient having an associated quantity;
using a printing processor connected to said user interface and to said database to receive the order for the meal and to transmit to a label printer at least one printing parameter, each printing parameter being a total nutritional parameter computed from at least one quantity of an ingredient comprised in the meal and from respective nutritional parameter for a specific amount of ingredient, or a personal parameter;
transmitting from the user interface the order for the meal to the printing processor;
using the printing processor to generate the at least one printing parameter and to transmit each printing parameter to a label printer; and
using the label printer connected to said printing processor to print a personalized label for the meal.

59. A as claimed in claim 58, further comprising:
providing a card reader and a purchaser loyalty card, wherein at least one between:
the order for the meal, and
a printing parameter,
is stored in the purchaser card, and wherein the card reader is configured to upload at least one between:
the order for the meal, and
a printing parameter,
to the interface;
using the loyalty card and card reader to upload to the interface at least one between:
the order for the meal, and
a printing parameter.

60. A computerized apparatus for ordering a meal in combination with performing price and nutritional calculations, the apparatus comprising:
a database;
a processor connected to said database;
an input device connected to said processor; and
an output device connected to said processor;
wherein the database comprises records representative of:
a plurality of food or beverage items, comprising each food or beverage item comprised in the meal, the meal comprising at least one consumable unit and each consumable unit comprising at least one food or beverage item, the meal comprising at least two food or beverage items;
values of at least one nutritional principle associated with each food or beverage item of said plurality of food or beverage items for a reference amount of food or beverage item;
values of at least one profit margin and at least one cost parameter associated with each food or beverage item of said plurality of food or beverage items for a reference amount of food or beverage item;
a plurality of consumable units, wherein at least one food or beverage item can be associated to each consumable unit of said plurality of consumable units;
wherein the input device is configured to receive an input comprising each consumable unit and each food or beverage item comprised in the meal, and is configured to select at least one monitor nutritional principle;
wherein the input device is configured to transmit said input to the processor for processing;
wherein the processor:
is programmed to receive said input,
is programmed to access said database to acquire a nutritional value for each selected monitor nutritional principle for each food or beverage item comprised in the meal,
is programmed to access said database to acquire values of a profit margin and a cost parameter for each food or beverage item comprised in the meal,
is programmed to calculate a total nutritional value for each selected monitor nutritional principle, each total nutritional value being given by a summation of terms, each term corresponding to a food or beverage item and each term being given by multiplying an acquired nutritional value by a corresponding amount of food or beverage item,
is programmed to calculate a total price of the meal given by a summation of terms, each term corresponding to a food or beverage item and each term being given by multiplying a difference between an acquired value of a profit margin and a cost parameter by a corresponding amount of food or beverage item, and
is programmed to output each total nutritional value and the total price of the meal to the output device;
wherein the output device is configured to display each total nutritional value and the total price of the meal; and
wherein the input device is operable to place an order for the meal.

61. A computerized apparatus as claimed in claim 60, wherein the database further comprises records representative of target nutritional values, wherein the processor is further programmed to acquire from the database a target nutritional value for each selected monitor nutritional principle and to output to the output device each acquired target nutritional value, and wherein the output device is further configured to display each acquired target nutritional value.

62. A computerized apparatus as claimed in claim 61, wherein the processor is further programmed to generate an alert if a total nutritional value is higher than a target nutritional value, and is further programmed to transmit said alert to the output device, and wherein the output device is further configured to output said alert.

63. A computerized method of ordering a meal in connection with price and nutritional calculations, the method comprising:
providing a database comprising records representative of:
a plurality of food or beverage items,
values of at least two nutritional principles associated with each food or beverage item of said plurality of food or beverage items for a reference amount of food or beverage item,
values of at least one profit margin and at least one cost parameter associated with each food or beverage item of said plurality of food or beverage items for a reference amount of food or beverage item,
a plurality of consumable units, wherein at least one food or beverage item can be associated to each consumable unit of said plurality of consumable units;
providing a user interface connected to said database and using the user interface to receive a selection of at least one consumable unit from said plurality of consumable units;
for each selected consumable unit, using the user interface to receive a selection of at least one food or beverage item associated with the selected consumable unit, wherein a total of at least two food or beverage items are selected, and wherein each selected food or beverage item has an associated quantity;
using the user interface to receive a selection of at least one monitor nutritional principle;
providing at least one processor, each processor connected to said interface and to said database;
for each selected food or beverage item, using a processor to access said database and to acquire a value of a nutritional principle for a reference amount of food or beverage item for each selected monitor nutritional principle;
for each selected food or beverage item, using a processor to access said database to acquire values of a profit margin and a cost parameter for a reference amount of food or beverage item;
using a processor to calculate a total nutritional value for each selected monitor nutritional principle, each total nutritional value being given by a summation of terms, each term corresponding to a selected food or beverage item and each term being calculated by multiplying an acquired nutritional principle for a reference amount of food or beverage item by a corresponding amount of selected food or beverage item;
using a processor to calculate a total price of the selected food or beverage items given by a summation of terms, each term corresponding to a selected food or beverage item and each term being given by multiplying a difference of acquired values of a profit margin and a cost parameter by a corresponding amount of food or beverage item;
using the user interface to display each total nutritional value and the total price of the selected food or beverage items; and
using the user interface to receive an order for the meal, the meal comprising at least one selected consumable unit and each consumable unit comprising at least one selected food or beverage item, the meal comprising at least two selected food or beverage items.

64. A computerized method as claimed in claim 63, the method further comprising:
in the database, providing further records representative of target nutritional values;
using a processor to acquire from the database a target nutritional value for each selected nutritional principle;
using a processor to transmit to the user interface each acquired target nutritional value; and
using the user interface to display each acquired target nutritional value.

65. A computerized method as claimed in claim 64, the method further comprising:
using a processor to generate an alert if a total nutritional value is higher than a target nutritional value;
transmitting said alert to the output device; and
using the user interface to output said alert.

66. A computerized apparatus for discounting a price of a meal, the apparatus comprising:
a database;
a processor connected to said database; and
an input device connected to said processor;
wherein the database comprises records representative of:
a plurality of food or beverage items, said records comprising at least one record of food or beverage item comprised in the meal having an associated discount parameter;
wherein the input device is configured to receive an input comprising each consumable unit and each food or beverage item comprised in the meal, the meal comprising at least one consumable unit and each consumable unit comprising at least one food or beverage item;
wherein the input device is configured to transmit said input to the processor for processing;
wherein the processor:
is programmed to receive said input;
is programmed to access said database to acquire at least one discount parameter associated with a food or beverage item comprised in the meal, and
is programmed to calculate a total discount applicable to the meal.

67. A computerized apparatus as claimed in claim 66, wherein each record of food or beverage item comprised in the meal further has an associated value representing a stocked total quantity of ingredient, and wherein the associated discount parameter is linked to said associated value of stocked total quantity.

68. A computerized apparatus as claimed in claim 67, wherein the processor is further programmed to access the database and update each value representing a stocked total quantity of each of food or beverage item comprised in the meal.

69. A computerized apparatus as claimed in claim 66, wherein the associated discount parameter depends on a requirement of a user of the apparatus.

70. A method of discounting a price of a meal, the method comprising:
providing a database comprising records representative of a plurality of food or beverage items, said records comprising at least one record of food or beverage item comprised in the meal having an associated discount parameter;
providing a processor connected to said database; and
providing an input device connected to said processor;
using the input device to receive an order for each consumable unit and each food or beverage item comprised in the meal, the meal comprising at least one consumable unit and each consumable unit comprising at least one food or beverage item;
transmitting said input to the processor for processing;
using the processor to receive said input, to access said database to acquire at least one discount parameter associated with a food or beverage item comprised in the meal, and to calculate a total discount applicable to the meal.

71. A method as claimed in claim 70, wherein, in the database, each record of food or beverage item comprised in the meal further has an associated value representing a stocked total quantity of ingredient, and wherein the associated discount parameter is linked to said associated value of stocked total quantity, the method further comprising:
using the processor to update each value representing a stocked total quantity of each of food or beverage item comprised in the meal.

72. A method as claimed in claim 70, wherein, in the database, the associated discount parameter depends on a user requirement, the method further comprising:
using the input device to input the user requirement to determine the associated discount parameter.

73. A storage medium storing computer readable code for implementation by a computer or network of computers, the code comprising:
code to provide a database comprising records representative of:
a plurality of food or beverage items,
values of at least two nutritional principles associated with each food or beverage item of said plurality of food or beverage items for a reference amount of food or beverage item,
a plurality of consumable units, wherein at least one food or beverage item can be associated to each consumable unit of said plurality of consumable units;
code to provide a user interface to receive a selection of at least one consumable unit from said plurality of consumable units in said database and, for each selected consumable unit, to receive a user selection of at least one food or beverage item associated with the selected consumable unit, wherein a total of at least two food or beverage items are selected, and wherein each selected food or beverage item has an associated amount;
code to, for each selected food or beverage item, provide access to said database to acquire at least two values of nutritional principles, the nutritional principles for which values are acquired corresponding to at least two monitor nutritional principles common to all the selected food or beverage items;
code to calculate at least two total nutritional values, each total nutritional value being given by a summation of terms, each term corresponding to a selected food or beverage item and each term being calculated by multiplying an acquired value of a nutritional principle by an associated amount of selected food or beverage item;
code to display the total nutritional values and to receive an order for a meal, the meal comprising at least two selected food or beverage items.

74. A storage medium storing computer readable code for implementation by a computer or network of computers, the code comprising:
code to provide a database comprising records representative of a plurality of ingredients, wherein at least two attributes are associated with each ingredient, one of the at least two attributes being a nutritional parameter for a specific amount of each corresponding ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user;
code to provide a user interface to receive a proposed order for a meal, the meal comprising one or more ingredients, each ingredient having an associated quantity, and to select at least one desired output parameter, the desired output parameter being a total nutritional parameter computed from each quantity of ingredient comprised in the meal and from respective nutritional parameter for a specific amount of ingredient stored in the database, or a personal parameter; and
code to retrieve information about the proposed order, said information comprising at least the desired output parameter and further programmed to output said information to the user interface.

75. A storage medium storing computer readable code for implementation by a computer or network of computers, the code comprising:
code to provide an ingredients database comprising records representative of a plurality of ingredients, wherein at least two attributes are associated with each ingredient, one of the at least two attributes being a nutritional parameter for a specific amount of each ingredient, and another of the at least two attributes being a personal parameter, said personal parameter being:
a parameter capable of describing the suitability of each ingredient associated with a medical condition of a user; or
a parameter capable of describing the suitability of each ingredient associated with a taste requirement of a user;
code to provide a stock database comprising records representative of a plurality of quantities of ingredients stocked at a meal preparation station, and records representative of recipes, each recipe comprising a set of instructions for preparing a meal,
code to provide a user interface to receive an input for a proposed order for a proposed meal, the proposed meal comprising one or more proposed ingredients, each proposed ingredient having an associated proposed quantity, and programmed to transmit the proposed order for the proposed meal to an ordering processor;
code to generate information about the proposed meal, said information comprising at least one output parameter, said output parameter being a total nutritional value computed from at least one quantity of proposed ingredient comprised in the proposed meal and from respective nutritional parameter for a specific amount of proposed ingredient, or a personal parameter, and programmed to transmit said information about the proposed meal to the user interface, wherein the user interface is further programmed to visualize said information;
code to visualize said information;
code to receive an order for a meal;
code to store in the stock database a recipe for the meal;
code to retrieve from said stock database said recipe for the meal;
code to update in said stock database each record of each stocked ingredient comprised in the meal;
code to receive an input to finalize the proposed order for the proposed meal into the order for the meal, the meal comprising at least one ingredient, each ingredient having an associated quantity, and to transmit said meal order to the order fulfilment processor;
code to retrieve said recipe for the meal and transmit it to a staff user interface;
code to update in the database the record or records representative of the quantity or quantities of the stocked ingredient or ingredients comprised in the meal after the order for the meal has been transmitted to the order fulfilment processor; and
code to visualize said recipe for the meal on the staff user interface.

76. A computerized method of ordering a meal in a food and beverages retail outlet according to nutritional information about the meal provided to a user of the outlet, the method comprising:
providing a database comprising records representative of:
a plurality of food or beverage items available at the retail outlet, values of at least two nutritional principles associated with each food or beverage item of said plurality of food or beverage items for a reference amount of food or beverage item,
a plurality of consumable units, wherein at least one food or beverage item can be associated to each consumable unit of said plurality of consumable units;
using a user interface at the retail outlet to receive a selection of at least one consumable unit from said plurality of consumable units in said database;
for each selected consumable unit, using the user interface at the retail outlet to receive a user selection of at least one food or beverage item associated with the selected consumable unit, wherein a total of at least two food or beverage items are selected and wherein each selected food or beverage item has an associated amount;
for each selected food or beverage item, using a processor to access said database to acquire at least two values of nutritional principles, the nutritional principles for which values are acquired corresponding to at least two monitor nutritional principles common to all the selected food or beverage items;
using the processor to calculate at least two total nutritional values, each total nutritional value being given by a summation of terms, each term corresponding to a selected food or beverage item and each term being calculated by multiplying an acquired value of a nutritional principle by an associated amount of selected food or beverage item;
using the user interface to display the total nutritional values to the user at the retail outlet; and
ordering the meal at the food and beverages retail outlet, the meal comprising the at least two selected food or beverage items.
